(19) United States
(12) Patent Application Publication
(10) Pub. No.: US 2002/0052807 A1
(43) Pub. Date: May 2, 2002

(54) Network architecture-based design-to-order system and method

(76) Inventors: Tao-Yag Han, Marietta, GA (US); Samir L. Hanna, Atlanta, GA (US)

Correspondence Address: NIXON & VANDERHYE P.C., 8th Floor, 1100 North Glebe Road, Arlington, VA, 22201, US

(21) Appl. No.: 09/888,372

(22) Filed: Jun. 26, 2001

Related U.S. Application Data
(60) Provisional application No. 60/214,260, filed on Jun. 26, 2000.

(51) Int. Cl. G06F 15/16; G06F 17/60

(52) U.S. Cl. 705/27; 709/205; 705/10

(57) ABSTRACT

A product design server system which forms the heart of a design-to-order product community. The design-to-order product community is an on-line community that provides a dynamic environment in which community participants can interact on the fly and instantaneously respond to product changes. The architecture of the product design server system, and the special product definition data structure utilized thereby, is network-based (e.g., web-based). The product design server system of the present invention goes beyond web-enabled and IP-based architectures by providing a pure internet architecture approach. Interaction with the product definition data, and thus participation in the design-to-order product community, is enabled through browser-application service suites. These application service suites, described subsequently in more detail, enable community participants, as individuals or teams, to use a standard web browser to create, find, access, understand, manipulate, and publish product information (e.g., the product definition data 60) to enhance their unique roles in the product lifecycle.

This application claims the priority and benefit of U.S. Provisional Patent Application Serial No. 60/214,260, filed Jun. 26, 2000, which is incorporated herein by reference. This applications is related to U.S. patent application Ser. No. 09/603,616, filed Jun. 26, 2000, entitled “NETWORK DISTRIBUTED DESIGN DATA EXCHANGE ARCHITECTURE AND SERVICES”, which is incorporated herein by reference in its entirety.

### BACKGROUND

A portion of the disclosure of this patent document contains material which is subject to copyright protection. The copyright owner has no objection to the facsimile reproduction by anyone of the patent document or the patent disclosure, as it appears in the Patent and Trademark Office files or records, but otherwise reserves all copyright rights whatsoever.

1. Field of the Invention

The present invention pertains to the computer aided design of products, and particularly to a network-based product design server system which facilitates collaboration of many participants throughout the lifecycle of product generation.

2. Related Art and Other Considerations

New products have traditionally been designed using a fairly sequential product design approach. Historically the product design approach typically has involved a sequence of relatively consecutive steps, such as steps S1-S5 illustrated in FIG. 1. A first step (step S1) involved conceptual design of the product, which was followed by a detailed design step (step S2). After the detailed design, a prototype of the product was built in a prototyping step (S3). Subsequent to prototyping of the product, there would be interactions with suppliers for components of the product (step S4). The interactions with the suppliers may result in some modification of the product design, depending upon availability of the specific types of components envisioned for the product design. The interactions with suppliers ultimately would lead to issuance of a purchase order for the components. With the supply of components assured, the step of manufacturing (step S5) could begin.

With the advent of the graphical web browser, the Internet became an information superhighway through which businesses could communicate and exchange information, such as the interaction of supplier and manufacturer represented by step S4 in FIG. 1. The Internet comprises a vast number of computers and computer networks that are interconnected through communication links. The interconnected computers exchange information using various services, such as the World Wide Web (WWW). The web service allows a server computer system (i.e., a Web server or Web site) to send graphical web pages of information to a remote client computer system. The remote client computer system can then display the web pages.

Each resource (e.g., computer or web page) of the WWW is uniquely identifiable by a Uniform Resource Locator (“URL”). To view a specific web page, a client computer system specifies the URL for that web page in a request (e.g., a HypterText Transfer Protocol [“HTTP”] request). The HyperText Markup Language (HTML) facilitates how documents can be presented on a screen, e.g., as web pages. The request is forwarded to the web server that supports that web page. When that web server receives the request, it sends that web page to the client computer system. When the client computer system receives that web page, it typically displays the web page using the aforementioned browser. A browser is a special-purpose application program that effects the requesting of the web pages and the displaying of web pages.

In 1998, the Extensible Markup Language (XML) was standardized as a newer language for delivering information over the web, enhancing software processing of structured information transmitted across the web. XML facilitates information exchange and processing, enabling business-to-business commerce and collaboration.

The Internet has not only enhanced the rate of business communications, but altered the nature of many transactions as well. For example, using the Internet some companies essentially “build to order” by allowing their customers to participate on-line in the picking and choosing of components/accessories (primarily pre-built components/accessories) for customizing a basic product marketed by the company. The customer of a computer manufacturer can specify, for example, what type of memory chips and/or peripheral equipment (disk drives, etc.) are to be included in the computer which the manufacturer will build or have built in accordance with the specifications. Other companies or services engage in “price to order” transactions, permitting a customer to specify a price for a certain product and ascertain if any supplier agrees to the specified price. Internet-based shipping services allow customers on-line to divert products which have been ordered to alternate destinations (e.g., “ship to order”).

Similarly, with differing degrees of sophistication, product developers have learned to use the Internet to convey product design data between parties involved in the product design process (e.g., suppliers, engineers), thereby accelerating product design. Some of that data can be three dimensional geometric modeling data which is utilized by three dimensional geometric modeling programs (e.g., CAD programs) to generate a scene or part comprising one or more constituent 3D shapes. However, myriad three dimensional geometric modeling programs are currently in use. Unfortunately, differing three dimensional geometric modeling programs may have differing geometric engine types. As a result, in communicating three dimensional geometric modeling data between two companies, some type of translation is often required (whether transmission be by internet or otherwise).

What is evolving is a “design-to-order” approach in which the marketplace impacts the creation, innovation, and design of products, and hopefully where every participant can have a unique one-to-one interaction with a product. Design-to-order products are coming within reach and becoming increasingly important for companies. Manufacturers, enabled by new technologies and driven by a desire for marketplace differentiation, are racing to produce the highly tailored products that can help them secure enduring customer loyalty. The faster that participants in the design process can agree on the right design (which is the cheapest to manufacturer and best for the consumer), the more successful is the product design endeavor.

But just how a design-to-order system is set up (e.g., the architecture of the system) and operated is critical to its responsiveness and flexibility. One current design-to-order approach, illustrated in FIG. 2A, utilizes a web-enabled architecture. In the web-enabled architecture, a web server is grafted onto an existing database system (e.g., a legacy database system). A proprietary server is positioned between the web server and the database system. A protocol translation is required from the web server to the proprietary server. Web access to the proprietary server requires custom coded application programmable interfaces (APIs). Moreover, web access to the data must understand a complex relational database schema/structure (RDBMS).

Another current design-to-order approach is the internet-protocol (IP)-based architecture shown in FIG. 2B. In the IP-based architecture, the web server is integrated into the proprietary server. The proprietary server can communicate directly using the web protocol, but the web access to the data still must understand the complex relational database schema/structure.

Unfortunately, the web-enabled and IP-based architectures involve a database schema/structure which is essentially structured as rows and columns. Operation of such a matrix type of schema/structure requires knowledge of the specific location for a data item (row/column), or some pre-built searcher to locate the data item. Moreover, the dimensions of the database/file system of the web-enabled and IP-based architectures are either predominately static or only awkwardly modified (e.g., using the relational database technology wherein additional databases are mapped into the primary database/file system using a double interaction technique).

Relational database technology requires a complex schema to be understood and encoded in meta data tables, resulting in the long expensive implementation cycles that are renowned with enterprise software. In addition, a risk of major corruption exists if the meta data becomes out of synchronization with the real data.

### BRIEF SUMMARY OF THE INVENTION

A product design server system which forms the heart of a design-to-order product community. The design-to-order product community is an on-line community that provides a dynamic environment in which community participants can interact on the fly and instantaneously respond to product changes. The architecture of the product design server system, and the special product definition data structure utilized thereby, is network-based (e.g., web-based). The product design server system of the present invention goes beyond web-enabled and IP-based architectures by providing a pure internet architecture approach. Interaction with the product definition data, and thus participation in the design-to-order product community, is enabled through browser-based application service suites. These application service suites, described subsequently in more detail, enable community participants, as individuals or teams, to use a standard web browser to create, find, access, understand, manipulate, and publish product information (e.g., the product definition data 60) to enhance their unique roles in the product lifecycle.

The product design server system comprises several servers, including an index server for facilitating access to a file system; a communications protocol server (e.g., web server) for handling transactions over a communications network (e.g., the internet); and an applications server. The applications server executes the application services. The applications server itself includes an information server which actually accesses file system 32, a set of tools; and various application server components as hereinafter described.

The product design server system can be deployed as a node or portal of a communications network, e.g., the Internet. Alternatively, the product design server system can be deployed as part of an local area network (LAN) or enterprise network (WAN), in which case even community participants outside the LAN/WAN can participate (e.g., when authorized, over the Internet).

The product definition data structure used by and with the product design server system of the present invention is an XML data structure schema, and is designed to be flexible (e.g., can have many optional elements). In essence, the product definition data encapsulates pertinent product information data for a product. The general types of data included in product definition data 60 include product identification (ID) data; part number data; alternate part number data; bill of materials data; a document group data; product specification data; product change history data; and, product interaction rules data.

The product definition data facilitates many features of the product design server system. one such feature is the existence of multiple levels of data storage definition, e.g., dictionary and instance levels of product definition data storage . Another such feature is the use of associative generation or “inter-specification” rules which enable creation of an instance level product definition data structure for a part number from a family product definition data structure at a dictionary level. Another feature is a delineation between a product definition data and the process data (e.g., process document 220) which utilizes the product definition data. Yet another feature facilitated by the product definition data is notification of changes in the product definition data to documents, etc., which utilize the product definition date for that product. Further, the product definition data also includes inter-product rules that particularly concern generation permissible combinations of individual parts or products.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of a traditional product design approach.

FIG. 2A is a diagrammatic view of a web-enabled architecture system.

FIG. 2B is a diagrammatic view of an IP-based architecture system.

FIG. 3 is a diagrammatic view of a collaborative product design approach facilitated by the present invention.

FIG. 4 is a schematic view of a design-to-order system in accordance with an example embodiment of the invention.

FIG. 4A is a schematic view showing the design-to-order system of FIG. 4 employed as a portal or node of the Internet.

FIG. 4B is a schematic view showing the design-to-order system of FIG. 4 employed as node of a local area network or enterprise network.

FIG. 5 is a schematic view of the design-to-order system of FIG. 4, showing in greater detail portions of an application server.

FIG. 6 is a diagrammatic view of a representative application service executed by an application server.

FIG. 7 is a diagrammatic view of a product definition data as well as network application services which can use the product definition data to generate an input file such as that transmitted from one company to another.

FIG. 8 is a diagrammatic view of an example data structure for product definition data for a product.

FIG. 8A is a diagrammatic view of portions of an another example data structure for product definition data for a product, particularly a structure having two sets of bill of materials.

FIG. 9A is a diagrammatic view illustrating example features of multiple levels and associative generation rules facilitated by the data structure for product definition data for a product according to an embodiment of the invention.

FIG. 9B(1)-FIG. 9B(4) and FIG. 9C(1)-FIG. 9C(2) are diagrammatic views illustrating other example features facilitated by the data structure for product definition data for a product, including utilization of inter-product associative/specification rules.

FIG. 10 is a diagrammatic view illustrating an order of presentation of various example web pages generated by execution of a request for quote (RFQ) application service according to a mode of the invention.

FIG. 10A-FIG. 10C are diagrammatic views illustrating in more detail respect subsets of the various web pages of FIG. 10.

FIG. 11 is a diagrammatic view of packet contents for a newly created request for quote (RFQ).

FIG. 12A is a diagrammatic view of web page contents of a request for quote (RFQ) find web page.

FIG. 12B is a diagrammatic view of web page contents of a request for quote (RFQ) view web page.

FIG. 12C is a diagrammatic view of web page contents of a request for quote (RFQ) question web page.

FIG. 12D is a diagrammatic view of web page contents of a request for quote (RFQ) activity web page.

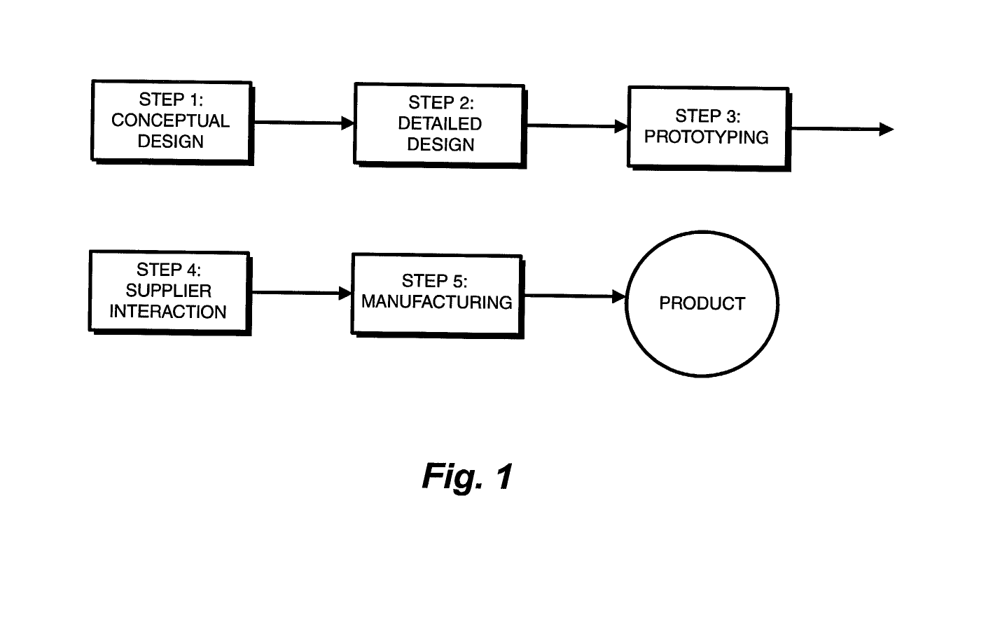

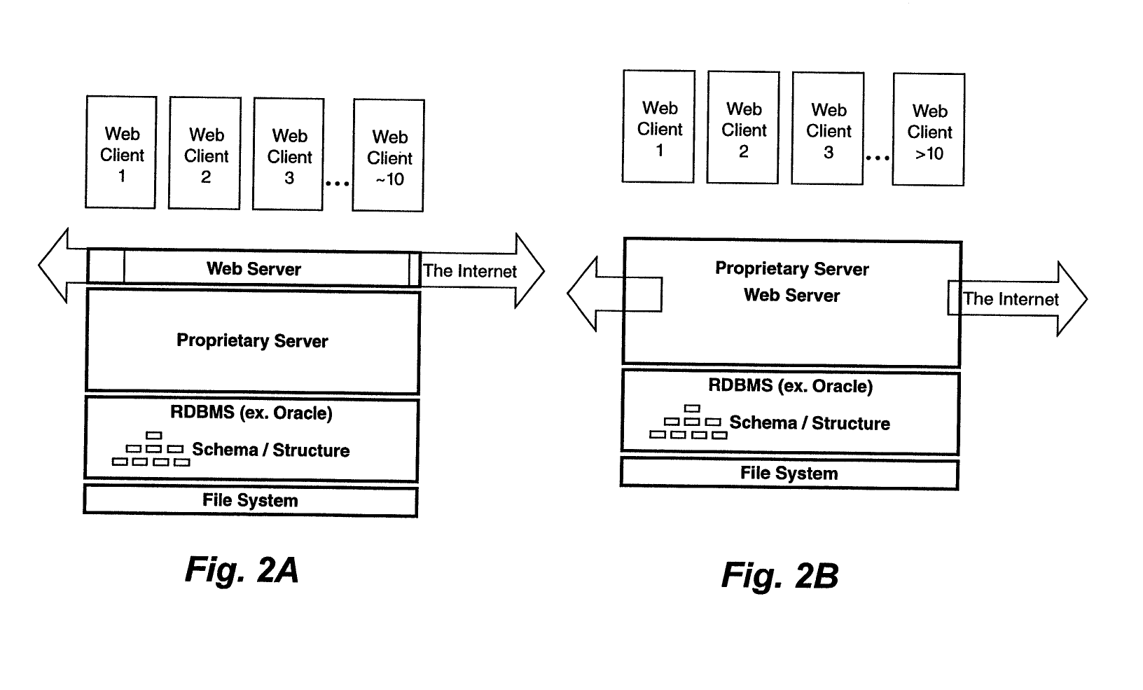

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

### PRODUCT DESIGN COMMUNITY

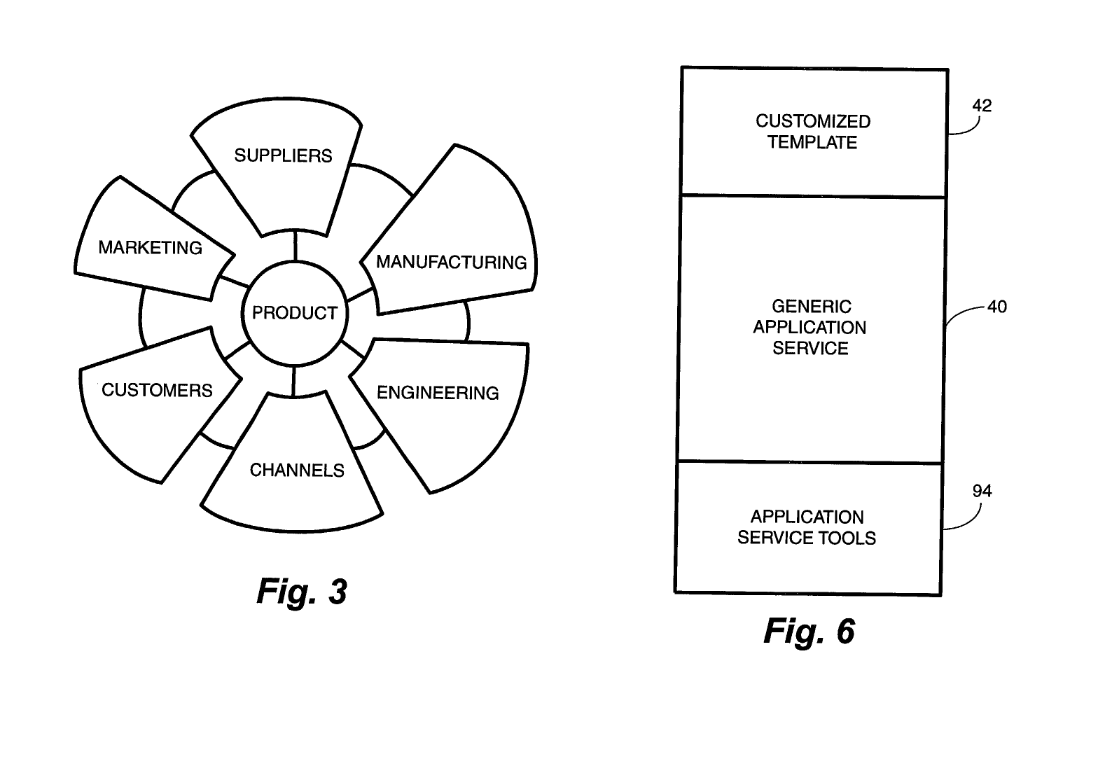

The present invention has, among its environments of interest, particularly utility in a design-to-order product community such as that illustrated in FIG. 3. The design-to-order product community is an on-line community that provides a dynamic environment in which community participants can interact on the fly and instantaneously respond to product changes. The design-to-order product community is browser-based and easy to use. The design-to-order product community allows visual communication in three dimensions, which enables deeper understanding of data, conveys product information that words cannot, and overcomes language and format barriers. Additional, the design-to-order product community provides community participants with built-in expertise in the form of a powerful and portable knowledge base that ties complex product information (e.g., product definition data) to the context of that information. When product changes occur, all relevant data can be instantly updated, and affected community participants are informed.

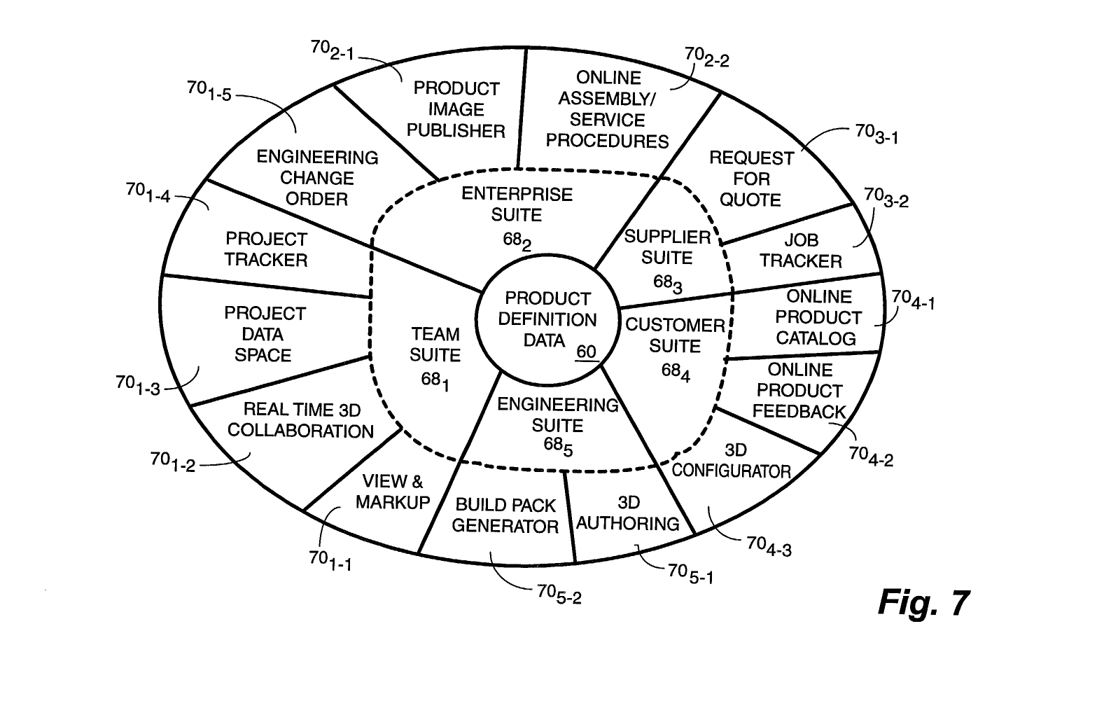

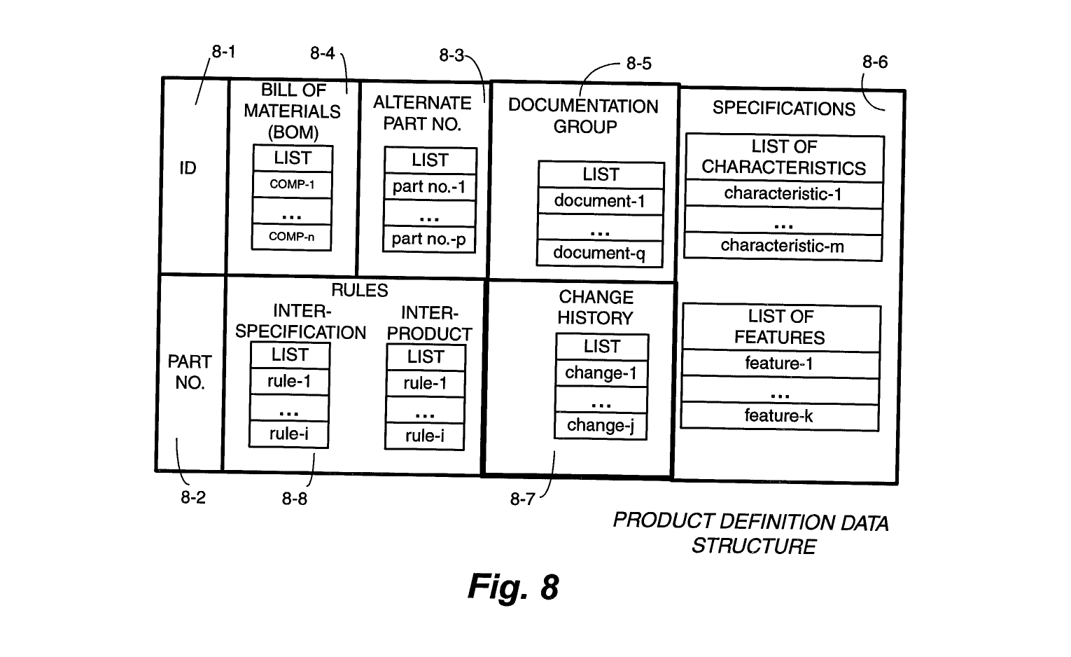

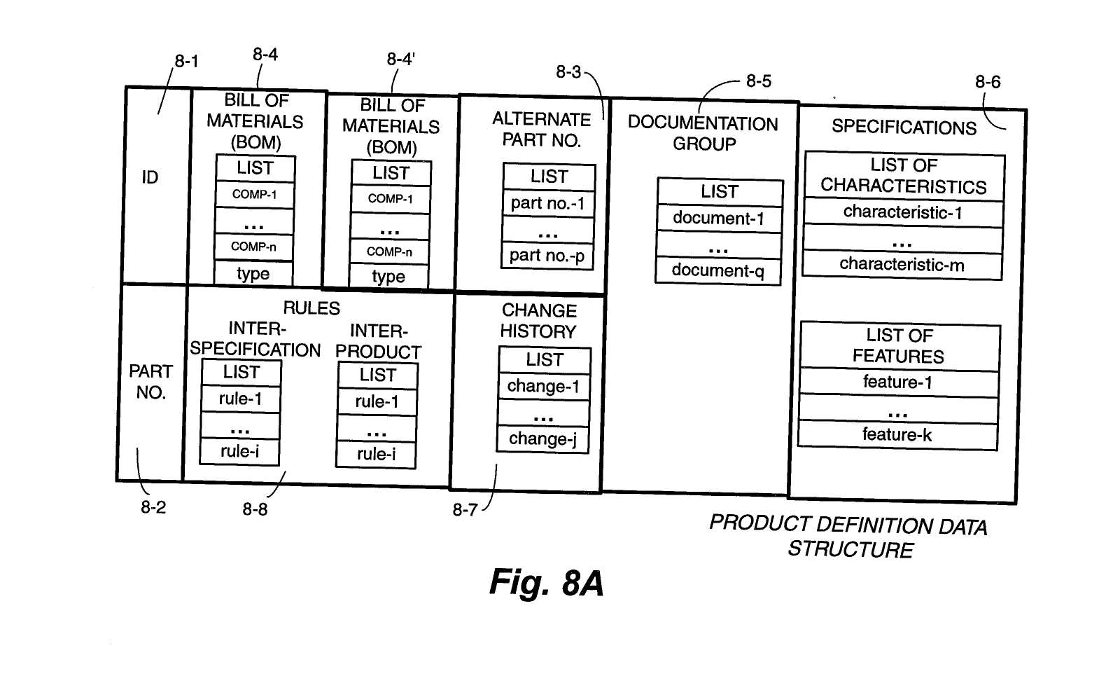

The product information utilized by the design-to-order product community is in the form of product definition data 60, which is described in more detail below. Interaction with the product definition data, and thus participation in the design-to-order product community, is enabled through application service suites such as the example services/suites illustrated in FIG. 7. These application service suites, described subsequently in more detail, enable community participants, as individuals or teams, to use a standard web browser to create, find, access, understand, manipulate, and publish product information (e.g., the product definition data 60) to enhance their unique roles in the product lifecycle.

### DESIGN SERVER SYSTEM

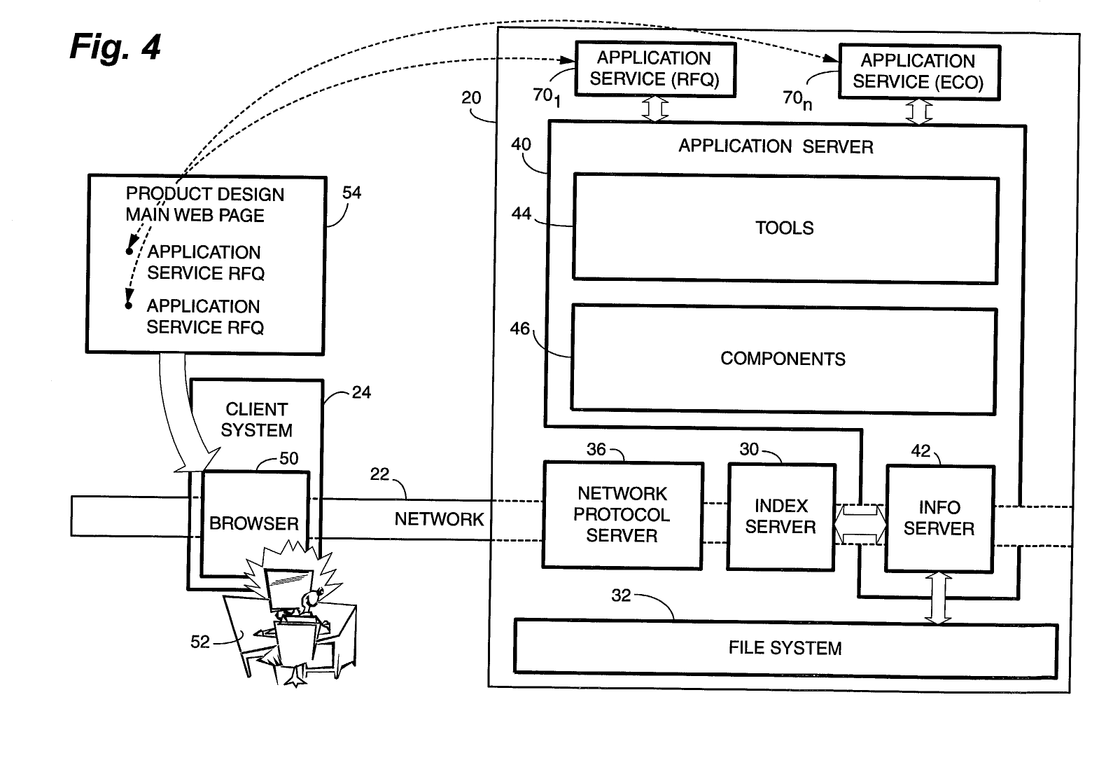

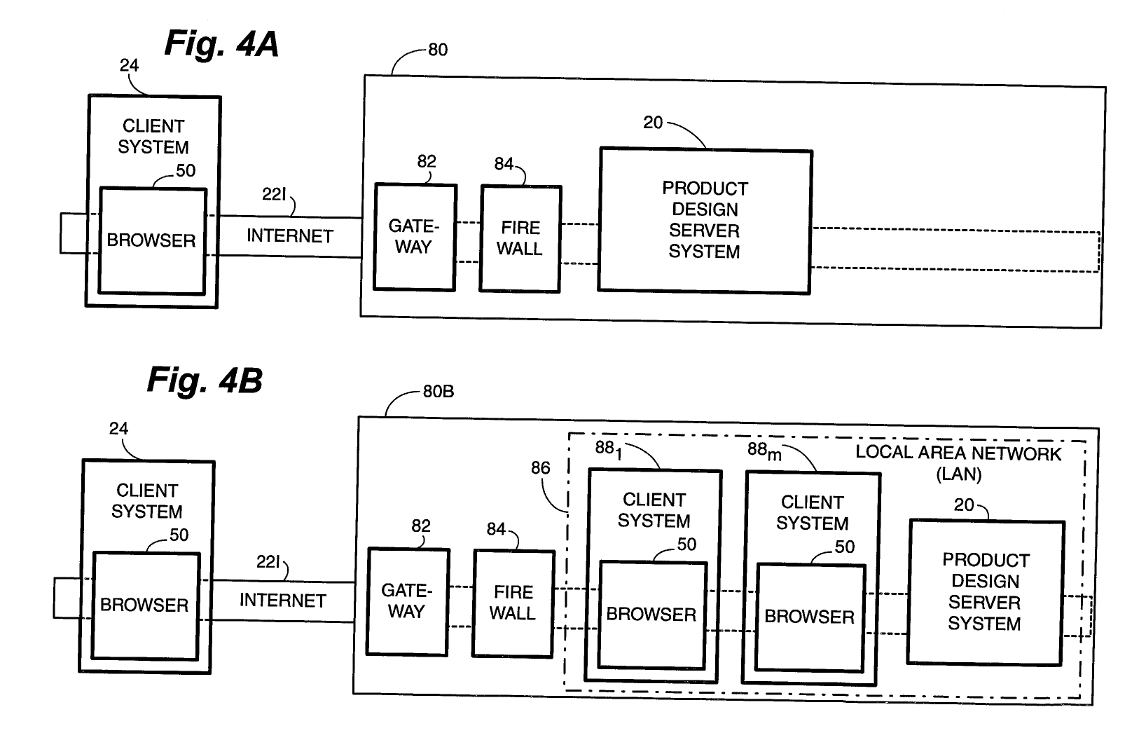

FIG. 4 is a schematic view of a product design-to-order system in accordance with an example embodiment of the invention. The design-to-order system includes a server system 20 which communicates over a communications network 22 with client systems, of which one client system 24 is shown in FIG. 4. Product design server system 20 comprises several servers, including an index server 30 for facilitating access to file system 32; a communications protocol server 36 for handling transactions over communications network 22; and an applications server 40. The applications server 40 itself includes an information server 42 which actually accesses file system 32, a set of tools 44; and various application server components 46 as hereinafter described.

The client system 24 has a browser 50 which, when pointed to the network address of product design server system 20, obtains and displays for the community participant 52 of client system 24 a product design main web page 54. The product design main web page 54 includes links to various product design application services 70ₗ-70ₙ which are executed by applications server 40. The product design application services 70ₗ-70ₙ can be those example application services illustrated in the application service suites of FIG. 7.

An example server suitable for use an information server 42 is disclosed in U.S. patent application Ser. No. 09/182,893, entitled “INTERNET-BASED INFORMATION MONITORING SYSTEM”, incorporated herein by reference.

FIG. 4A shows a particular example deployment of product design server system 20 at a node or portal 80 of the Internet 221. As such, product design server system 20 is behind a gateway 82 and firewall 84 of node 80A, but such that authorized client systems such as client system 24 can communicate with product design server system 20. An alternate example deployment, illustrated in FIG. 4B, shows product design server system 20 situated as a node 80B of a local area network (LAN) 86 to which numerous LAN-connected client computers 88ₗ-88ₘ are also connected. In the deployment of FIG. 4B, the local area network (LAN) 86, and hence product design server system 20, are behind gateway 82 and firewall 84 of node 80B. Node 80B is connected via Internet 221, with some client systems on Internet 221 having authorization to utilize product design server system 20. Other deployments of product design server system 20 are also possible, including deployment as part of an enterprise network.

### APPLICATION SERVER

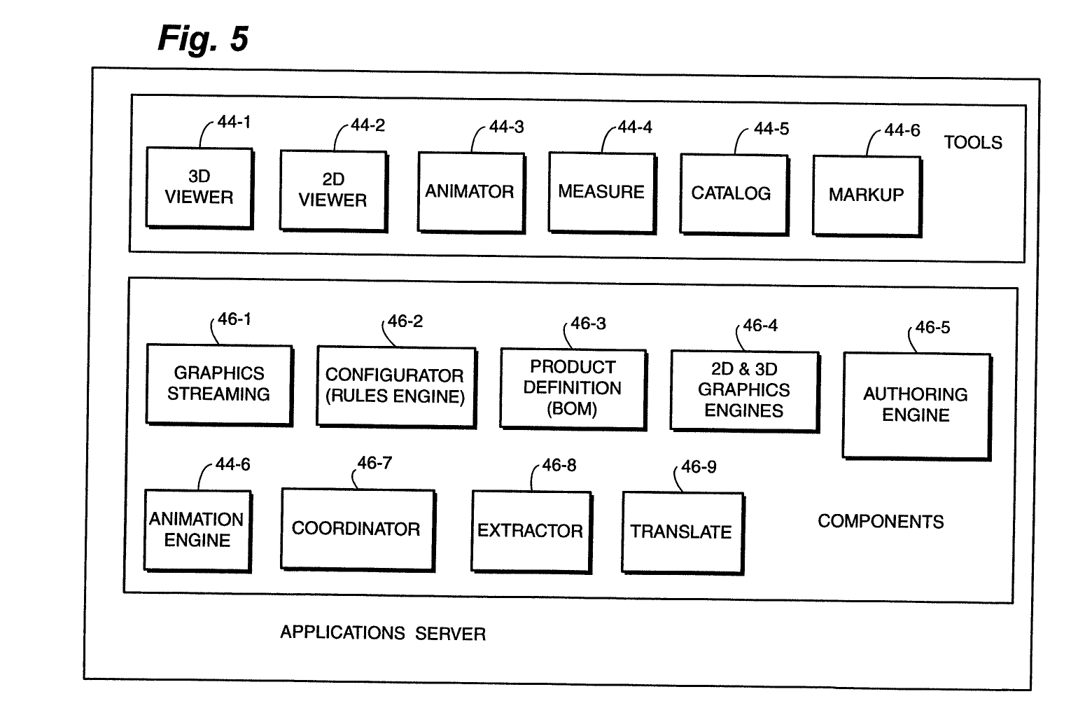

FIG. 5 is a schematic view of the applications server 40 of FIG. 4 showing in greater detail the tool portion 44 and components portion 46. Among the tools 44 provided by applications server 40 are the following: 3D-viewer tool 44-1; 2D-viewer tool 44-2; animator tool 44-3; measuring tool 44-4; catalog tool 44-5; and markup tool 44-6. Unlike most of the product design application services 70, the tools 44 do not have any specific business-related operation. Usage of some of these tools are described subsequently. As shown in FIG. 5, the application server components 46 include graphics streaming engine 46-1; rules engine (also known as the configurator) 46-2; product definition or BOM engine 46-3; 2D and 3D graphics engines 46-4; an authoring engine 46-5; a coordinator 46-7; an extractor 46-8; and a converter 46-9. The application server components/engines 46 enable tools 44 to work. Other tools, engines and components of applications server 40 are not illustrated in FIG. 5. The tools and components are preferably software modules, such as Microsoft® COM (Component Object Modeling) modules. Details of component object modeling are understood by those skilled in the art, particularly with reference (for example) to such publications as Robertson, Dale, Inside COM (Microsoft Press, 1997), ISBN 1-57231-349-8.

The coordinator 46-7, which is useful, e.g., for converting files of data from one format of three dimensional geometric modeling data to another format, selectively invokes the extractor 46-8 and translator 46-9. Various aspects of coordinator 46-7 are described in U.S. patent application Ser. No. 09/603,616, entitled “NETWORK DISTRIBUTED DESIGN DATA EXCHANGE ARCHITECTURE AND SERVICES”, which is incorporated herein by reference in its entirety.

The catalog tool 44-5, when invoked, enables a participant to view numerous catalogs. Additionally, catalog tool 44-5 affords the participant an opportunity to drag and drop a part out of one of the catalogs into a work space being utilized by the participant.

The configuration engine 46-2, also known as the rules engine, checks the permissibility of community participant-entered options as a community participant attempts to configure a product by selecting options or features for building onto a basic foundation product. The configuration engine 46-2 has knowledge of the permissible combinations of components based on the properties or rules of the products (e.g., the rules or properties set forth in the specification data 8-8 of product definition data 60 [see FIG. 8]).

The authoring engine 46-5 uses the configuration engine 46-2 to allow a community participant to configure a valid part. For example, using the authoring engine 46-5 a computer designer may wish to author a laptop computer, and in so doing may select a certain CPU, memory chip, power supply, etc., from catalog tool 44-5. The configuration engine 46-2, using the rules set forth in the rules data 8-8 of product definition data 60, determines whether the combination of selected options is permissible.

The markup tool 44-6 allows a participant not only to view a product in two dimensions or three dimensions, but also allows the participant, during collaboration, to apply any label or marking to the graphical rendering. For example, for a particular product a participant may use markup tool 44-6 to post a graphical note indicating that a certain feature should be changed (e.g., “make thinner”). Using the markup tool 44-6, the participant can mark many aspects of the product, such as a certain region or face, for example. The markup tool 44-6can save each participant's markups as a separate file, each file having its own security to designate which other participants are entitled to view the marking participant's markups. When a participant's markup is subsequently opened, it is displayed as an overlay on the original graphical display underlying the markup.

### APPLICATION SERVICES

FIG. 5 also shows two product design application services 70₁ and 70₂, which are illustrated merely as an incomplete but representative sampling of the total available product design application services 70ₗ-70ₙ. In the illustrated example, the application service 70₁ is a request for quote (RFQ) application service, while application services 70₂ is an engineering change order application service. As with the other unillustrated product design application services 70, the product design application services 70₁ and 70₂ are browser based.

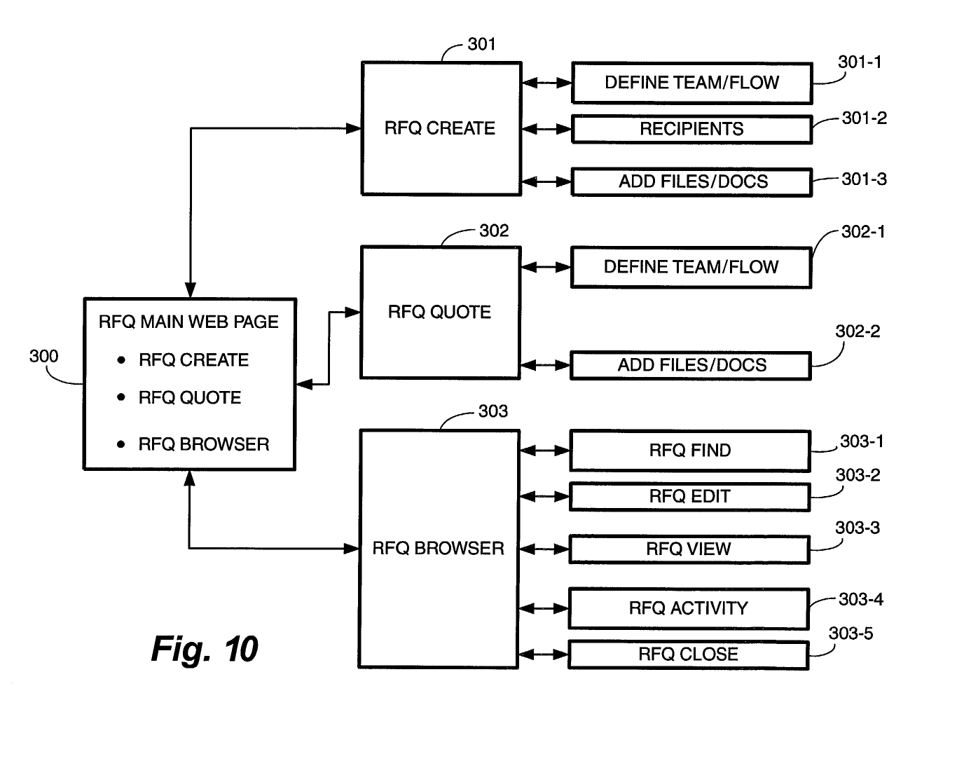

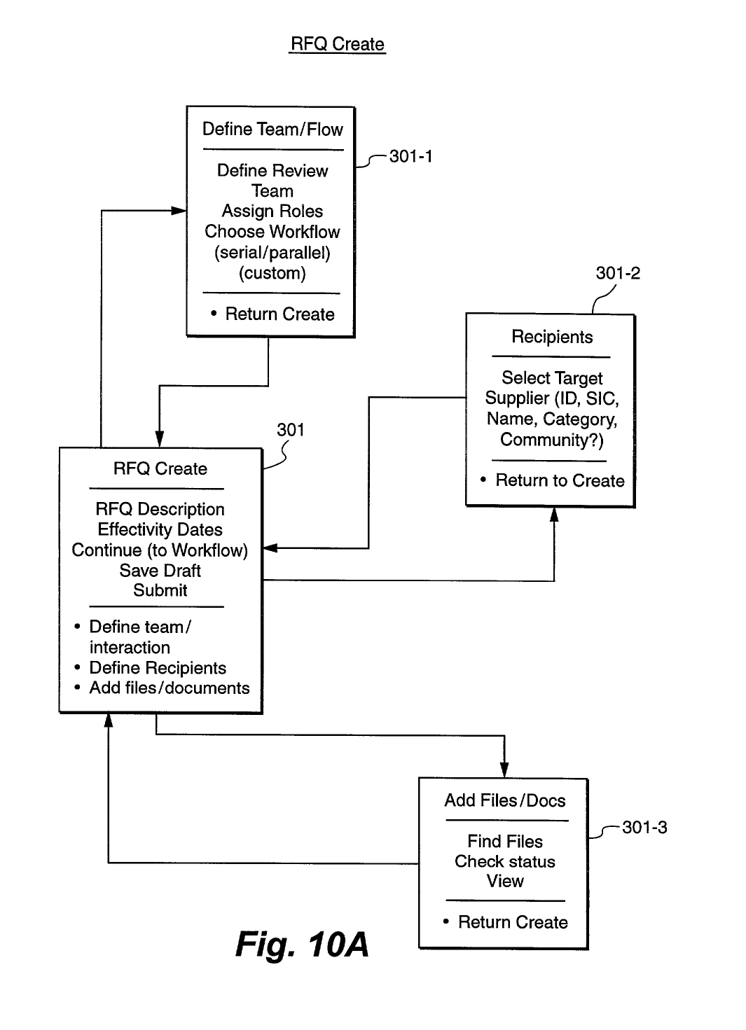

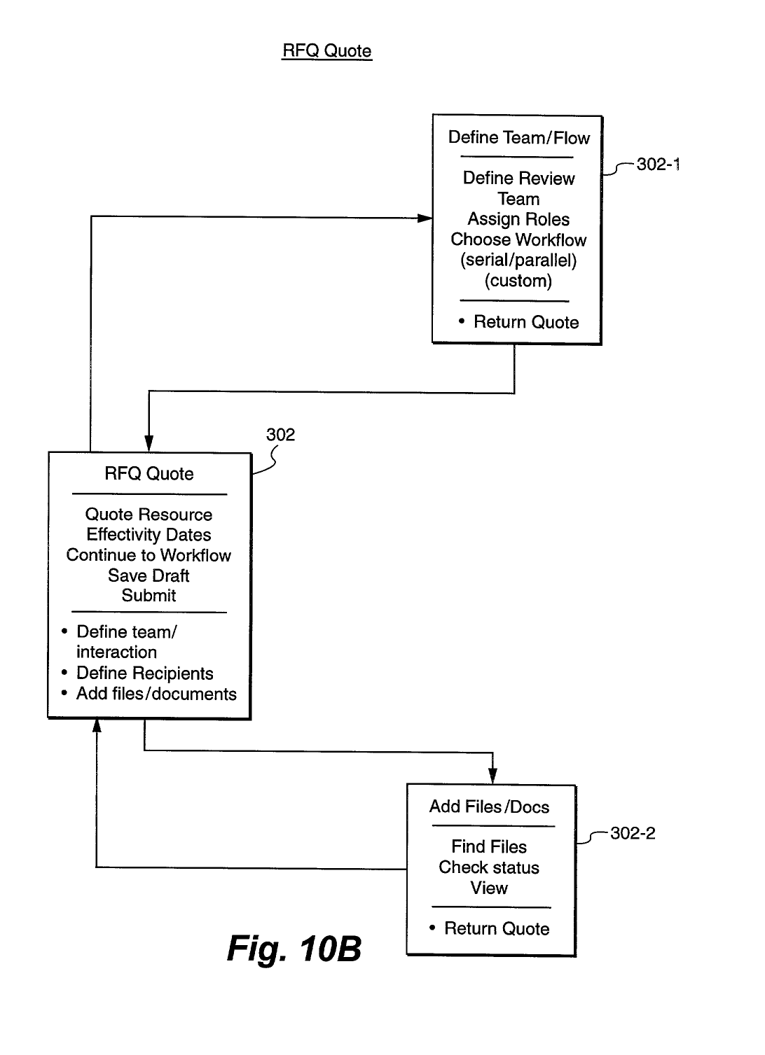

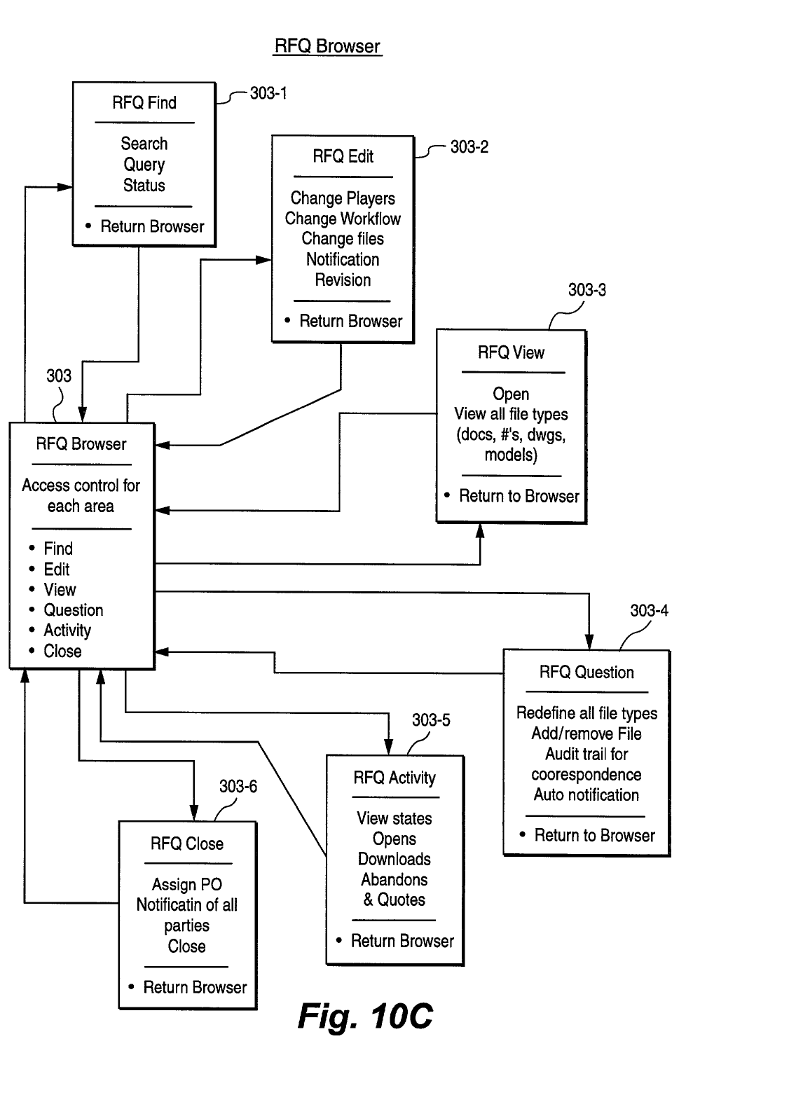

FIG. 6 depicts a representative one of the product design application services 70. An example product design application service 70 includes generic application service logic 90; a customized applications service template 92; and application service tools 94. For each product design application service 70, execution of its application service logic 90 enables interaction with client system 24 and the performance of certain design-related activities for a product. In particular, when client system 24 (viewing product design main web page 54 as shown in FIG. 4) clicks on a link to the product design application service 70, the product design application service 70 is executed by applications server 40. Execution of the product design application service 70 typically results in the transmission of further web pages to client system 24, and performance of certain actions by applications server 40 related to selections made by client system 24 from those further web pages. For example, product design application service 70₁ which pertains to a request for quote (RFQ) has logic which, when executed by applications server 40, results in transmission of one or more of the web pages illustrated in FIG. 10 and FIG. 10A-FIG. 10C, and the performance of actions associated with the options and features selected by community participant 52. In the course of its execution, the product design application service 70 may invoke one or more of its application service tools 94. An invocation of one of the application service tools 94 is actually an invocation of a corresponding one of the tools 44 in applications server 40. For example, the application service tools 94 of a product design application service 70 may include a catalog tool (an invocation of tool 44-5) and a viewer tool (e.g., an invocation of one of tools 44-1 or 44-2). It should also be noted that some of the tools 44 can themselves be product design application services 70.

Examples of network (e.g., web) application services are illustrated in FIG. 3 as an outer ring of services encircling product definition data 60. The application services are grouped in suits 68. In the illustrated embodiment, the suits of network applications services include the following: Team Participation Suite 68₁; Enterprise Participation Suite 68₂; Supplier Participation Suite 68₃; Customer Participation Suite 68₄; and Engineering Participation Suite 68₅.

The Team Participation Suite 68₁ is an interactive on-line environment where every member of a company's value network—customers, internal departments, suppliers, partners, and channels, for example—can have a one-to-one participation with a product. Participants, individually or in teams, can find, access, understand, manipulate and publish product information to enhance their unique role in the product creation and delivery process. The Team Participation Suite 68₁ provides the resources and environment to promote effective team participation and produce successful products. The Team Participation Suite 68₁ efficiently and effectively captures relevant input from the entire team, and provides team members with the information they need to contribute. The network application services provided in Team Participation Suite 68₁ include view & markup service 70₁₋₁; real time 3D collaboration service 70₁₋₂; project data space service 70₁₋₃; and project tracker service 70₁₋₄. The view & markup service 70₁₋₁ facilitates viewing and markup of numerous native data formats that can be accessed in any application service, as well as the viewing and markup of two dimensional and three dimensional data from numerous native data formats that can be accessed in any application service. The real time 3D collaboration service 70₁₋₂ provides services for real time collaboration among participants in diverse geographical locations, whether in the enterprise or the internet community. The project data space service 70₁₋₃ captures and logs interactions among people working on a project, including alerts, messages, revisions, and product history. The project navigator service 70₁₋₄ enables automatic tracking and routing of inputs and feedback from collaborative application services.

The Enterprise Participation Suite 68₂ enables business to create products by tapping the expertise and knowledge found throughout the organization and by extending relevant information to people who need it. The network application services provided in Enterprise Participation Suite 68₂ include engineering change order service 70₂₋₁; product image publisher service 70₂₋₂; and, online assembly/service procedures service 70₂₋₃. The engineering change order (ECO) service 70₂₋₁ allows a participant to perform or execute an engineering change order against a particular product. The product image publisher service 70₂₋₂ provides application services that can publish product data in powerful visualization formats, such as photo-realistic renderings and animations. The online assembly/service procedures service 70₂₋₃ enables people to obtain product data in native formats and extract relevant information in a format directly usable in many enterprise processes, such as collateral and assembly procedure creation, without having to recreate data.

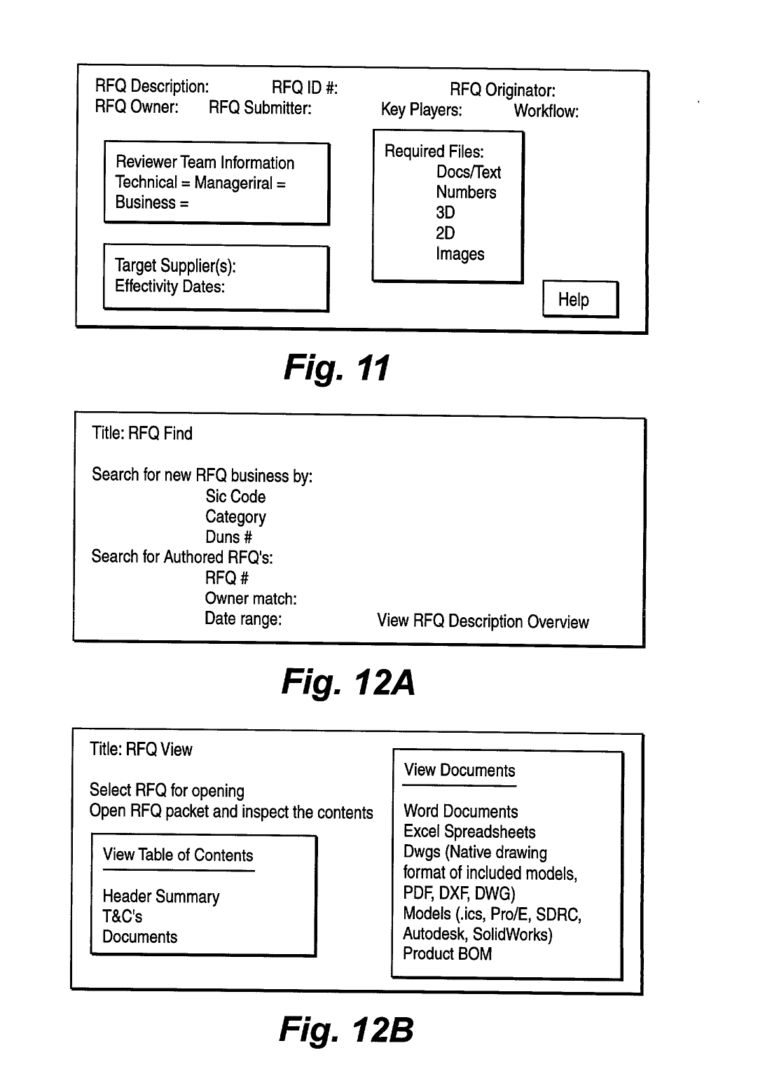

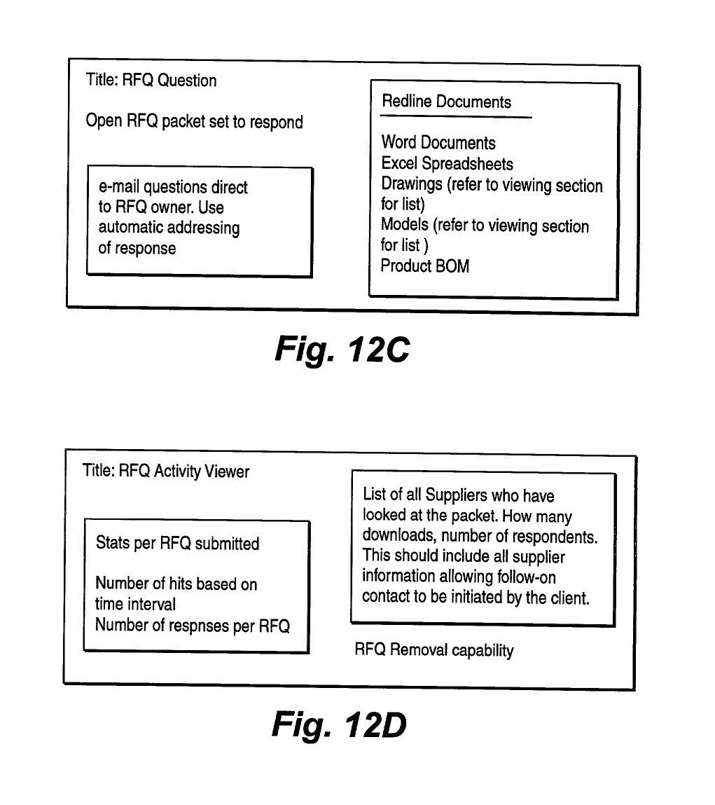

The network application services provided in Supplier Participation Suite 68₃ include request for quote (RFQ) service 70₃₋₁ and job tracker service 70₃₋₂. The request for quote (RFQ) service 70₃₋₁ enables a participant to create or edit a request for a quote (RFQ) for a needed service or product, as subsequently described in more detail in connection with FIG. 10 and FIG. 10A-FIG. 10C, FIG. 11, and FIG. 12A-FIG. 12D.

The Customer Participation Suite 68₄ allows customers to play an integral role in the product creation process. The network application services provided in Customer Participation Suite 68₄ include online product catalog service 70₄₋₁; online product feedback service 70₄₋₂; and 3D configurator service 70₄₋₃. The online product catalog service 70₄₋₁ supports the creation and maintenance of online catalogs of product data with the ability to include rich product data formats such as bill of materials (BOMs), two dimensional, and three dimensional drawings. Thus, the online catalog community participant has the power to visualize the product dynamically in three dimensions and even to download a three dimensional design model for direct use in most major design systems. The online product feedback service 70₄₋₂ enables manufacturers to publish product feedback request websites for their customers directly from the actual three dimensional design models. Thus, customers can visualize, inspect, and provide feedback on virtual three dimensional prototypes in a simple online environment with automated data collection and tabulation. Customers can modify elements of a product design in a conrolled fashion, posting the results automatically to the supply chain. The 3D configurator service 70₄₋₃ allows creation of dynamic and intelligent online product configurators with fast performance and simplified rules management through the embedding of rules in product objects.

The Engineering Participation Suite 68₅ enhances the productivity of everyone involved in authoring product data. The network application services provided in Engineering Participation Suite 68₅ include 3D authoring service 70₅₋₁ and build pack generator 70₅₋₂. The 3D authoring service 70₅₋₁ provides two dimensional and three dimensional authoring capability that delivers unprecedented productivity and usability, accelerates the learning curve and breaks down barriers to product creation. The 3D authoring service 70₅₋₁ offers an intuitive graphical handle-driven modification paradigm. Easy access is provided to most major CAD systems, including the ability to make new designs. The build pack generator 70₅₋₂ includes a fully integrated animation engine supporting drag and drop generation of virtual three dimensional animations that communicate product usage, as well as assembly and service procedures.

It will be appreciated that the names of the network application services, and specific data formats generated by the network application services, may vary in differing environments.

### PRODUCT DEFINITION DATA

FIG. 3 generally depicts the product definition data 60 as being central to various examples of suites of example application services. In essence, the product definition data 60 encapsulates pertinent product information data for a product. The general types of data included in product definition data 60 are illustrated in FIG. 8. These general types of data include product identification (ID) data 8-1; part number data 8-2; alternate part number data 8-3; bill of materials data 8-4; document group data 8-5; product specification data 8-6; product change history data 8-7; and, product interaction rules data 8-8. The product definition data 60 is communicated to the participants in a manner so that the product definition data 60 can be viewed, measured, interrogated, and manipulated (e.g., changed or marked up) as needed.

In one embodiment of the invention, the product definition data 60 is an XML data structure schema, and is designed to be flexible (e.g., can have many optional elements). Various aspects of the schema of an example embodiment are described in Tables 1-7. It should be understood that the product definition data structure underlying Tables 1-7 is an entire unit, and that the demarcations of the product definition data structure into tables such as Tables 1-7 is solely for sake of convenience to the reader. Therefore, all Tables 1-7 are to be interpreted together, and various statements in one table may have relevance to another.

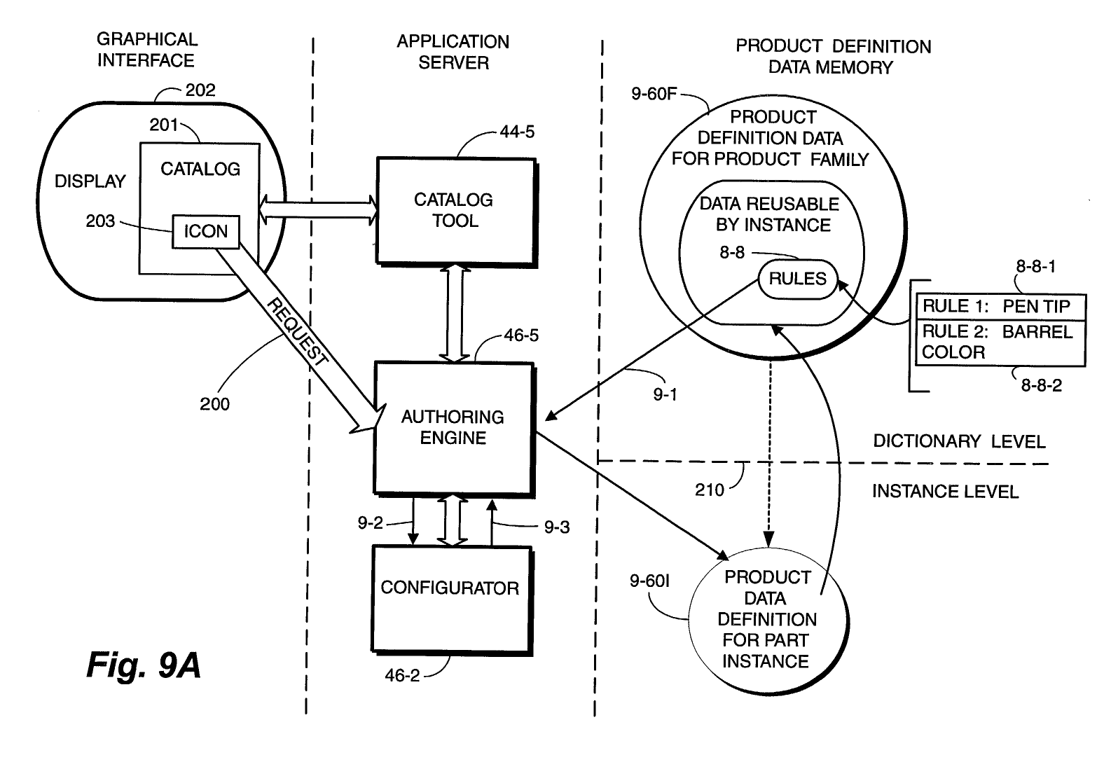

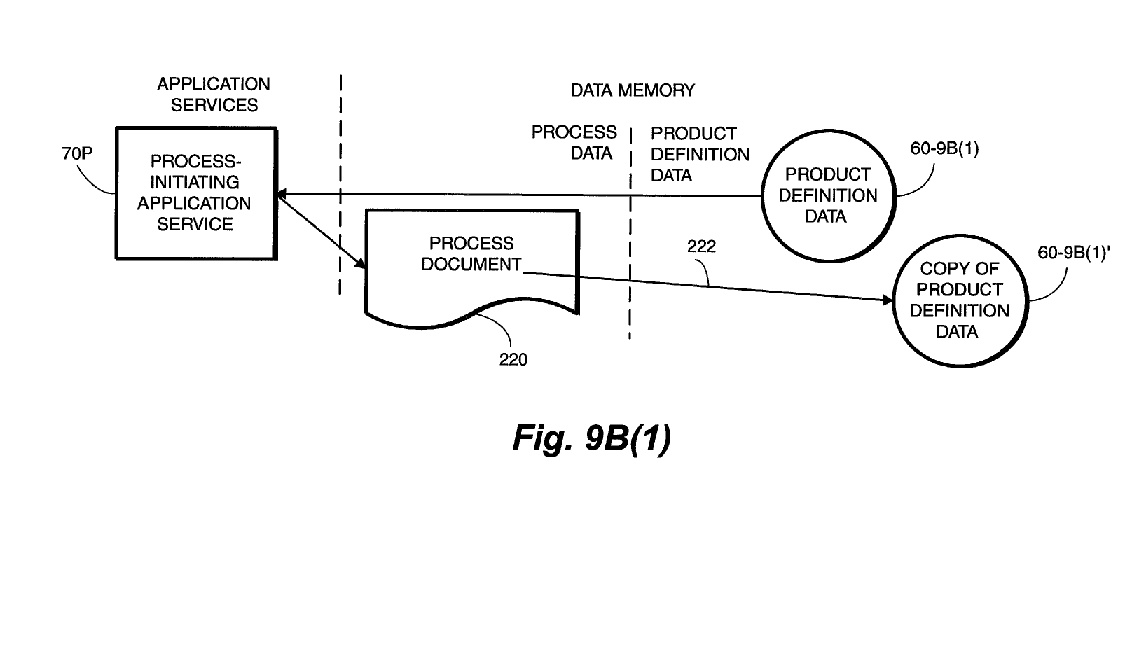

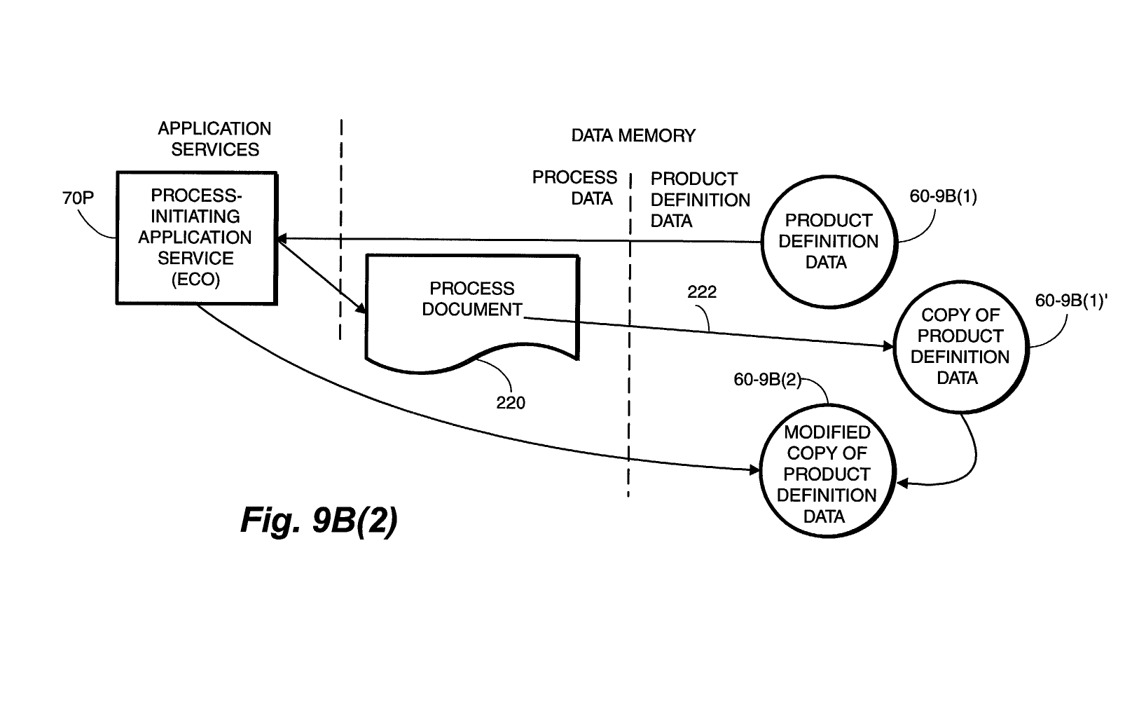

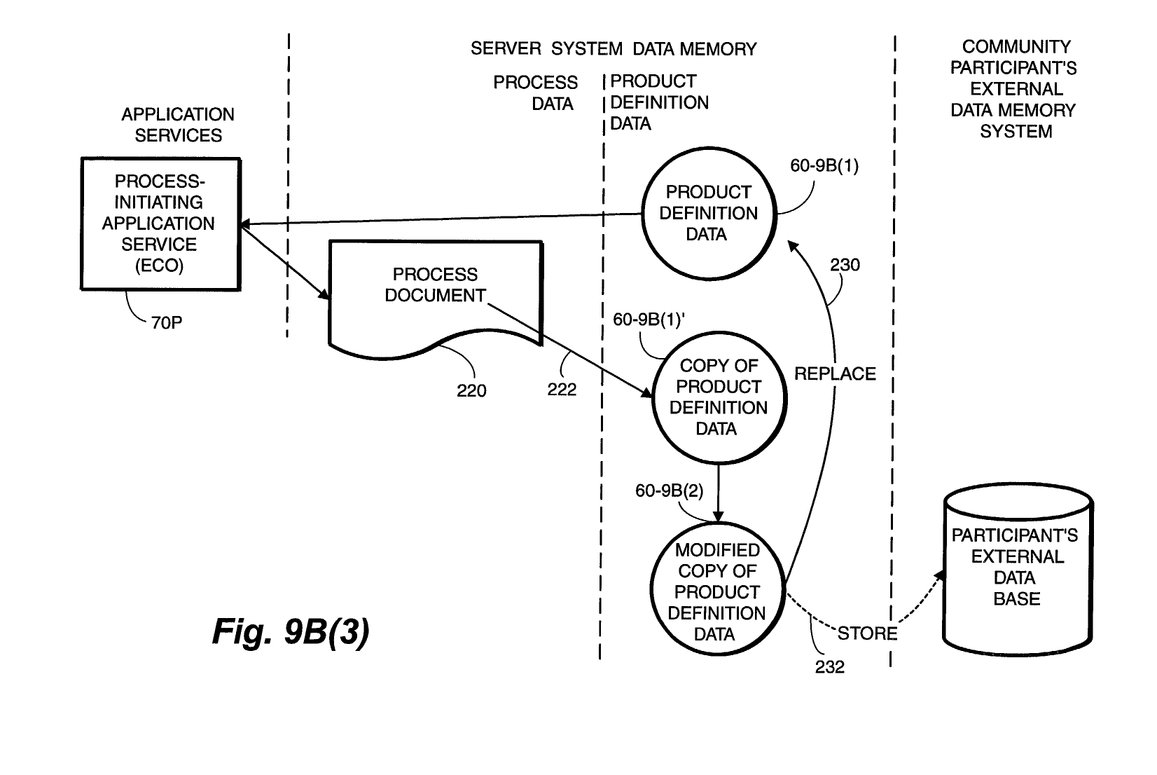

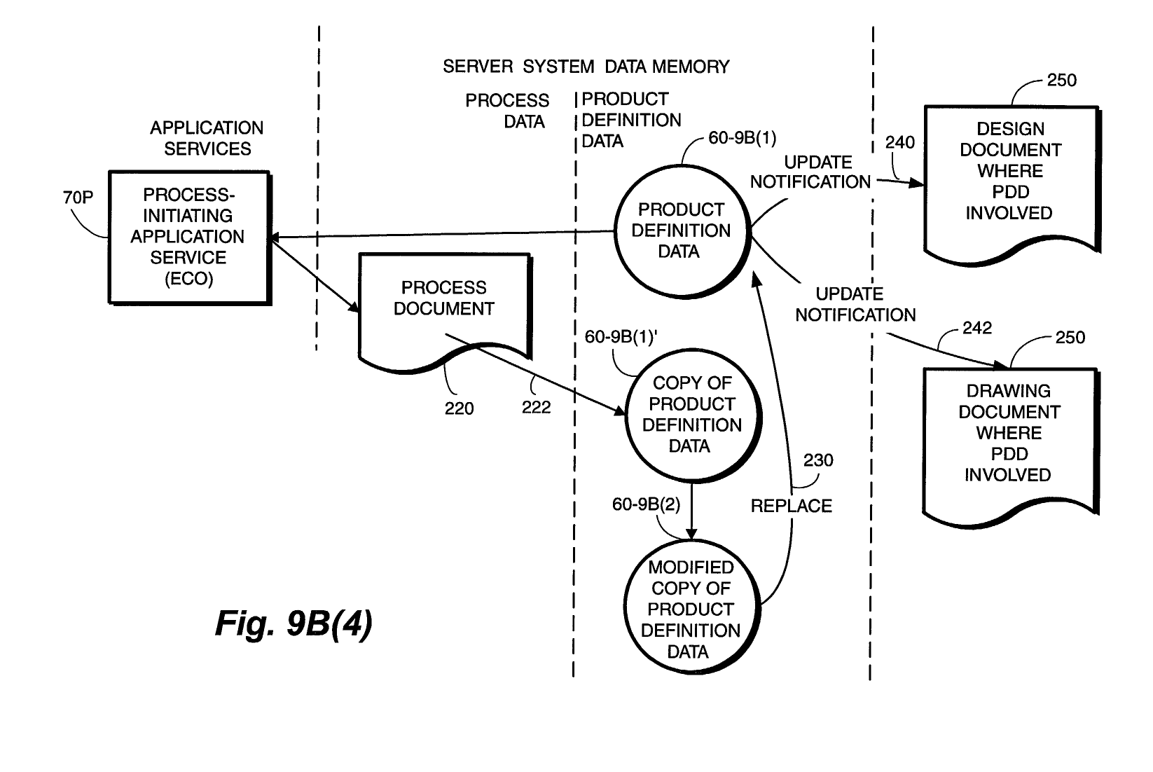

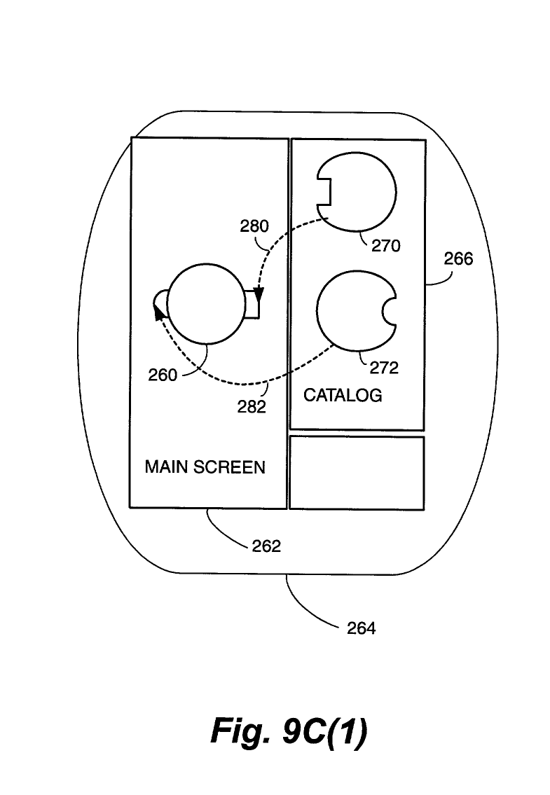

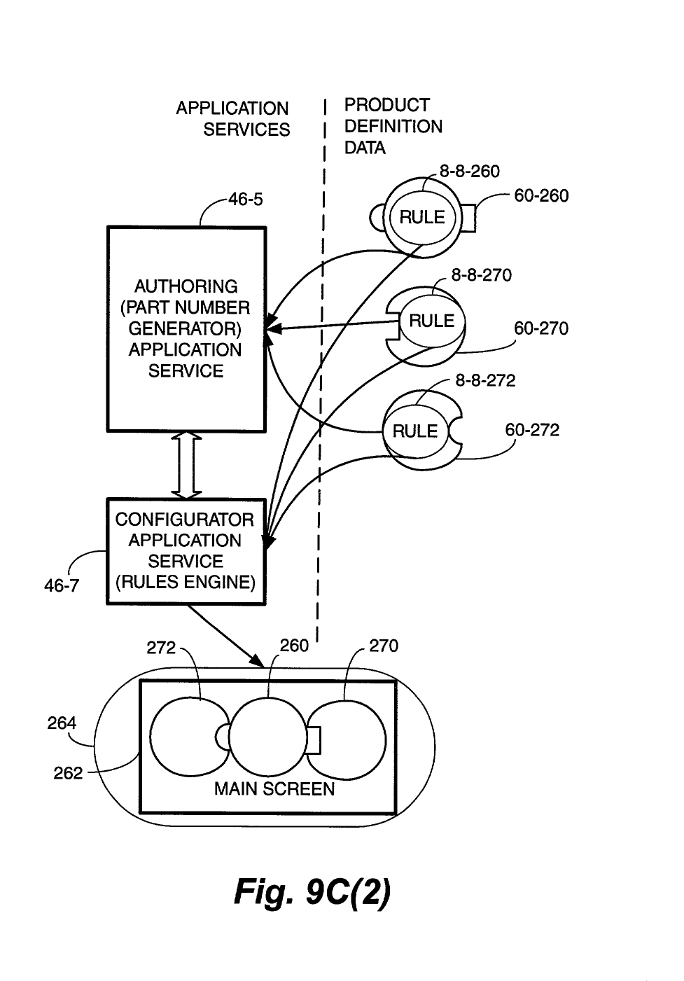

An example format of product identification (ID) data 8-1 for an example schema of product definition data 60 is illustrated in Table 1. The part number data 8-2 is used to associate a part number with the product and the organization (e.g., community participant) that uses the part number. As explained subsequently, e.g., with reference to FIG. 9A, the part number can have an associated generation rule which enables creation of an instance level product definition data structure for a part number from a family product definition data structure at a dictionary level.

The alternate part number data 8-3 contains other part numbers used to describe the same product, since typically suppliers, manufacturers, etc., use their own part numbering schemes. Therefore, the alternate part number data 8-3 helps to tie together, for a single product, the multiple part numbers that may be used by different community participants to refer to the same product. The alternate part number data 8-3 thus includes a list of alternate part numbers, the alternate part numbers being illustrated as list elements part no.-1 through part no.-p in FIG. 8 Example XML elements suitable for use as part number data 8-2 and alternate part number data 8-3 are illustrated in Table 2.

An example format of the bill of materials (BOM) data 8-4 for an example schema is illustrated in Table 3. The bill of materials data 8-4 includes a list of subcomponents, as well as descriptive information describing each subcomponent. In this regard, FIG. 8 shows bill of materials data 8-4 has having a list and subcomponents comp-1 through comp-n. Each subcomponent can, in turn, have its own product definition data 60. Moreover, there can be different types of bill of materials for corresponding different stages in the product lifecycle. For example, a different set of bill of material data can exist for each of a design stage and a production or assembly (manufacturing) stage of the product life. For example, the production/assembly bill of materials may be considerably more detailed than the design stage bill of materials for the product. In this regard, FIG. 8A shows a product definition data 90′ having two BOMs, including a first BOM 8-4 for a design stage of the product and a second BOM 8-4 for a manufacturing/assembly stage of the same product. Differentiation between the two BOMs 8-4 and 8-4′ exist by virtue of a BOM “type” element including in each set of BOM data.

The document group data 8-5 contains attachment documentation for a product. Examples of these document attachments are design files, drawings, and other product-related documents. However, process related documents such as engineering change orders and requests for quote are not included in the document group data 8-5. Thus, the document group data 8-5 serves, e.g., to capture the design and drawing documentation. The document group data 8-5 provides such information as geometric data, features, size information, and other attributes (such as color, surface finish, assembly process steps that must be performed, etc.). The document group data 8-5 thus includes manufacturing specific information. Further, the document group data 8-5 can include association data which establishes relationships between documents provided in document group data 8-5. When an association exists between two documents, if one of the associated documents undergoes a change, the change affects the other associated document as well. A list of document elements is shown in document group data 8-5 in FIG. 8, including document-1 through document-q. An example format of document group data 8-5 for an example schema is illustrated in Table 5.

The product specification data 8-6 includes a collection of all properties of the product. For example, the product specification data 8-6 includes a collection of characteristic elements and a collection of feature elements. A characteristic element represents a quantitative property with a range of allowable values and units. A list of characteristic elements is shown in product specification data 8-6 in FIG. 8, including characteristic elements for characteristic-1 through characteristic-m. A feature element represents a qualitative property with an enumeration of allowable values. A list of feature elements is shown in product specification data 8-6 in FIG. 8, including feature elements for feature-1 through feature-k. Both characteristic elements and feature elements describe a property of the product in a general manner. Another element, termed the specification element, contains the name and actual value for a property for a given product. An example format of product specification data 8-6 for an example schema is illustrated in Table 4.

The product change history data 8-7 records the changes a product has undergone with change_item elements. A list of change item elements is shown in product change history data 8-7 in FIG. 8, including change item elements for change-1 through change-j. Each change item element contains a reference to a specific change part number and a short description of the change made to the product. Typically, it contains a reference to an engineering change order (ECO). An example format of product change history data 8-7 for an example schema is illustrated in Table 6.

The product interaction rules data 8-8 is used to represent relationships or constraints among specification elements as well as among products in an assembly configuration. Two types of rules included in product interaction rules data 8-8 are InterProduct Rules or InterSpecification Rules. An example usage of the interspecification rules is described below with reference to FIG. 9A; an example of usage of the inter-product rules is described below with reference to FIG. 9C(1). A list of rules is shown in product interaction rules data 8-8 in FIG. 8, including rule-1 through rule-i. An example format of product interaction rules data 8-8 for an example schema is illustrated in Table 7.

FIG. 9A illustrates two features facilitated by product definition data 60. A first such feature is the existence of multiple levels of data storage definition. A second such feature is the use of associative generation or “interspecification” rules which enable creation of an instance level product definition data structure for a part number from a family product definition data structure at a dictionary level.

FIG. 9A shows a request 200 to author a new part being issued by a community participant to authoring engine 46-5. At this point it is presumed that the participant has also activated catalog tool 44-5, and that the catalog tool 44-5 enables the participant to view on a catalog portion 201 of a display screen 202 or the like and to select an icon or symbol 203, representative of a product family. For example, catalog tool 44-5 may display an writing instrument of the product family “pen”. FIG. 9A further shows the product definition data 9-60F for the product family, and that the product definition data 9-60F for the product family includes its interspecification rules such as that previously explained with reference to specification data 8-8 (see FIG. 8). In response to menu or dialog interrogation, the participant is permitted to specify certain features for the part being designed, e.g., in the example of the pen the features may be the type of tip the pen may have, as well as the color of the exterior barrel of the pen. As reflected by action 9-1 in FIG. 9A, the configuration engine 46-2 evaluates the input from the participant (depicted by arrow 9-2) with respect to the rules of the product family, e.g., interspecification rules 8-8 of product definition data 9-60F. In this example, a first rule 8-8-1 may specify (for example) that the type of tip that the pen may have, permitting either a felt tip, ballpoint, or fountain pen. A second rule 8-8-2 may specify the color of the pen's barrel, e.g., either silver or gold. Assuming that the selection of options or features for the part number being authored, configuration engine 46-2 advises authoring engine 46-5 (indicated by arrow 9-3) that the proposed part number is acceptable. Accordingly, authoring engine 46-5 generates a product definition data for the authored part number, shown as product definition data 9-60I in FIG. 9A.

FIG. 9A thus shows involvement of the application service components or engines—the catalog tool 44-5; the authoring engine 46-5; and the configuration or rules engine 46-2—in providing the associative generation rule feature of FIG. 9A.

The part number generated in accordance with the foregoing scenario of FIG. 9A is referred to as an “instance” of the product family. Significantly, the instance of the product definition data 9-60I is shown in FIG. 9A as being on an instance level of product definition data storage, whereas the product definition data for the product family is shown as being stored at a dictionary level. In FIG. 9A, the broken line 210 shows a demarcation between the dictionary level and the instance level of storage. In accordance with the present invention, all product family product definition data structures are stored at the dictionary level, whereas all product definition data structures for part numbers (such as those authored by authoring engine 46-5) are stored at the instance level. Thus, the present invention has multiple levels of storage of product definition data structures.

It is also significant in FIG. 9A that the product definition data 9-60I for the instance or part number is illustrated as being smaller (e.g., having a smaller radius) than the product definition data 9-60F for the product family. Such illustration corresponds to the fact that the product definition data 9-60I for the instance or part number does not need to duplicate or expressly include certain instance-usable data items of the product definition data 9-60F for the product family. In this regard, rather than re-storing the instance-usable data items of the product definition data 9-60F for the product family in the product definition data 9-60I for the instance or part number, the product definition data 9-60I for the instance or part number merely includes a pointer to such re-usable data elements of product definition data 9-60F. Such re-usable data elements include the rules or specifications 8-6. The reference to such re-usable data elements, rather than the restorage thereof, precludes double storage and thereby realizes a significant savings in memory.

Thus, for the present invention there are two levels of product definition data—the dictionary level and the instance level. At the dictionary level, a product or product family is described in a general manner. At the instance level, an instance of the product is described in more detail. The product definition data structure of the present invention captures considerable data for the product at the dictionary level, and the data at the dictionary level is utilized also at the instance level (unless overridden at the instance level). Having these two levels of abstraction, the dictionary level and the instance level, makes the product definition data structure more compact. In other words, common data items/elements and possible values or ranges of values for specifications 8-6 of a class or family of products are stored at the dictionary level. But specific instances refer to the dictionary for the definition of the data, and contain only a discrete subset of necessary values. Additionally, the dictionary may contain other common data such as design files that need not be duplicated in the instance.

The usage of the inter-specification rules in the aforementioned manner to generate an instance of a product from a product family illustrate the associative generation feature of the present invention.

FIG. 9B(1) illustrates another feature of the invention facilitated by product definition data 60. In particular, FIG. 9B(1) shows a particular application service 70P that generates a process using the product definition data in accordance with the present invention. The particular application service 70P could be, for example, the request for quote product design application service 70₁ which has been previously mentioned. The product design application service 70P is shown as using the product definition data 60-9B(1) of a certain product in order to generate a process document 220 with respect to the product definition data 60-9B(1). The process document 220 has a pointer 222 which points to its own copy of the product definition data 60-9B(1), e.g., product definition data copy 60-9B(1)′. The process document 220 is an XML document which includes process information affecting the product definition data, such as (for example) a definition of team members who can participate regarding the product and process and workflow information. Significantly, FIG. 9B(1) shows that the data structure memory for the present invention is delineated so a product definition data structure is segregated from the process data (e.g., process document 220) which utilizes the product definition data.

FIG. 9B(2) shows a situation in which a community participant or member uses the product design application service 70P in order to make a modification (which may be temporary) of the product definition data. In particular, FIG. 9B(2) shows usage of a product design application service 70, such as the engineering change order (ECO) application service 70₂ above mentioned, generated a modified copy 60-9B(2) of the product definition data 60-9B(1)′.

FIG. 9B(3) shows that, after generation of the modified copy 60-9B(2) of the product definition data 60-9B(1)′, the community participant decides that the modified copy 60-9B(2) is not to be temporary, but rather a replacement of the subsisting product definition data 60-9B(1). In this regard, FIG. 9B(3) shows by arrow 230 the modified copy 60-9B(2) actually replacing the subsisting product definition data 60-9B(1). Additionally, FIG. 9B(3) illustrates, as an optional event (depicted by arrow 232), the community participant storing the modified copy 60-9B(2) to his own database system (at the participant's own node). For example, the modified copy 60-9B(2) may be stored in the design database, financial database, supplier database, or manufacturing database of any database system separately maintained by the participant.

FIG. 9B(4) illustrates another feature facilitated by the product definition data 60 of the present invention, particularly the notification of changes in the product definition data 60. Upon storage of the update the subsisting product definition data 60-9B(1) in the manner described by FIG. 9B(3), in the present invention the fact of the update, as well as the nature of the update (e.g., how the product definition data was changed), in conveyed to other documents which also reference or utilize the product definition data 60-9B(1). For example, FIG. 9B(4) shows update notifications 240 and 242 being sent to each of a design document 450 which utilizes the product definition data 60-9B(1) and a drawing document which utilizes the product definition data 60-9B(1).

FIG. 9C(1) and FIG. 9C(2) illustrate yet another feature facilitated by the product definition data 60 of the present invention—utilization of inter-product rules. The inter-product rules of the product definition data 60 of the invention particularly concern generation permissible combinations of individual parts or products. FIG. 9C(1) shows that a part 260 has been created and is currently being displayed on a main screen 262 of display device 264 at a computer of a community participant's node. The part 260 is basically circular with both a rectangular protrusion on its right side and a semi-circular protrusion on its left side. The participant has invoked the catalog application server 46-6 so that at least portions of a catalog 266 are displayed, including additional parts 270 and 272. The part 270 is basically circular with a rectangular indentation on its left side; the part 272 is basically circular with a semi-circular indentation on its right side. In the scenario depicted in FIG. 9C(1) and FIG. 9C(2), the participant attempts to author or compose a combination part from the individual parts or products 260, 270, and 272 in the manner hereinafter described.

To effect the combination, the community participant selects, and drags and drops, each of the parts 270 and 272 in the manner depicted by broken lines 280 and 282, respectively, in FIG. 9C(1). FIG. 9C(2) shows that each of the individual parts or products 260, 270, and 272 have their respective product definition data structures 60-260; 60-270; and 60-272. Moreover, each of the product definition data structures 60-260, 60-270, and 60-272, include their respective inter-product specification data or rules, shown as rules 8-8-260; 8-8-270; and 8-8-272, respectively. The inter-product specification data or rules 8-8-260, 8-8-270, and 8-8-272 basically specify what types features are needed on any mating parts for the respective part/products to be combined or joined with the mating parts. For example, inter-product specification data or rule 8-8-260 requires that part 260 be mated on its right with a part having a rectangular indentation on its left side, and that it mating is to occur on the left side of part 260, that it be mated with a part having a semi-circular indentation on its right side. In similar manner, inter-product specification data or rule 8-8-270 requires that if mating is to occur for part 270, that the mating part have a rectangular protrusion on its right side. Likewise, inter-product specification data or rule 8-8-272 requires that if mating is to occur for part 272, that the mating part have a semi-circular protrusion on its left side.

The configuration or rules engine 46-2 evaluates the rules (e.g., inter-product rules 8-8-260, 8-8-270, and 8-8-272) in the course of the attempted combination (e.g., the drag and drop operations), and overrules any impermissible combination of parts/products. For example, if an attempt were made to mate a part without a rectangular indentation to the right of part 260, a warning notification would be generated for observation by the participant. But in the present scenario the combinations of parts 260, 270, and 272 are permitted by the respective inter-product rules, so that a resulting combination such as that appearing in the main screen 262 of FIG. 9C(2) is generated.

The scenario of FIG. 9C(1) and FIG. 9C(2) illustrates an example in which the inter-product rules are primarily concerned with geometric features of the parts/products being combined. Yet the inter-product rules are not confined to geometric features, but encompass a broad range of interaction characteristics. For example, the inter-product rules can specify validity/invalidity of a combination based on properties, performance characteristics, and limitations/preferences of one or more of the parts being combined. For example, considering a product such as a liquid pump, one inter-product specification/rule might specify to what diameter pipe the pump inlet or outlet can be connected; another inter-product specification/rule might specify what type of liquid (e.g., water, oil, but not acid) can be taken into the pump; another inter-product specification/rule might specify what pumping rate is acceptable for the pump.

### EXAMPLE WEB PAGES FOR EXAMPLE PRODUCT DESIGN APPLICATION SERIVCE

As mentioned above, when a community participant 52 points his/her browser 50 to the network address of product design server system 20, the product design main web page 54 is displayed at the computer terminal of the community participant 52. As shown in FIG. 4, the product design main web page 54 provides the community participant 52 with links to a set of product design application services 70 from which to select. For sake of simplicity, product design main web page 54 as displayed in FIG. 4 only shows two product design application services 70, i.e., request for quote (RFQ) application service 70₁ and engineering change order application service 70₂. It should be understood, particularly from FIG. 7, that product design main web page 54 can display numerous other product design application services 70, and can group the product design application services 70 by suites 68.

In the example scenario of FIG. 10, taken together with FIG. 10A-FIG. 10C, FIG. 11, and FIG. 12A-FIG. 12D, it is presumed that the link for the request for quote (RFQ) application service 70₁ is clicked or otherwise selected by community participant 52 on product design main web page 54. The clicking on the link to the request for quote (RFQ) application service 70₁ results in applications server 40 executing the request for quote (RFQ) application service 70₁. In essentially immediate response to the click, execution of the request for quote (RFQ) application service 70₁ results in a RFQ main web page 300 being transmitted to browser 50 of client system 24.

Certain contents of the RFQ main web page 300, and the existence of a tree of subsidiary RFQ web pages, are illustrated in FIG. 10. Regarding contents of the RFQ main web page 300, FIG. 10 shows links to three second tier subsidiary web pages, particularly RFQ create/edit web page 301; RFQ Quote web page 302; and RFQ Brower web page 303. Although not shown in detail in FIG. 10, in similar fashion, each of the three second tier subsidiary web pages 301, 302, and 303 have links to third tier subsidiary web pages which are described subsequently with reference to FIG. 10A, FIG. 10B, and FIG. 10C. Thus, FIG. 10 illustrates an order of presentation of various example web pages generated by execution of a request for quote (RFQ) application service according to a mode of the invention.

The purpose of the RFQ create/edit web page 301 is to allow a community participant 52 to create or edit a request for quote (RFQ) for a needed service or product. Using the RFQ create/edit web page 301, an individual or a designated company team comprised of technical, business, and management representatives can compose a packet of information forming the RFQ. Team creation allows additional options that permit the specification of a simple set of workflow rules that outline the RFQ creation, review, and submittal process. Each team member is responsible for adding all appropriate files for their portion of the RFQ. A single individual is designated as the owner and as such has responsibility for editing and/or final submittal, and is included in all notification messaging.

FIG. 10A shows in more detail the RFQ create/edit web page 301, as well as a second tier of web pages 301-1, 301-2, and 301-3 for which RFQ create/edit web page 301 has links. Using RFQ create/edit web page 301 and its subsidiary web pages 301-1 through 301-3 the community participant 52 can initiate a new request for quote (RFQ). The RFQ is assigned a specific identification number by which it can be tracked throughout its life. The RFQ is a container/packet having example contents illustrated in FIG. 11, and is in a form that describes the scope of the RFQ, the owner, the review team (business, technical, etc.), and any required data files (documents, text, drawing, model, etc.). The required data files are appended or added using web page 301-3. Using web page 301-1, the community participant 52 defines the players, assigned roles, and the interaction workflow for the RFQ. Using web page 301-2, the community participant 52 defines which supplier(s) are to receive the new RFQ packet, which can vary from a single entity to a group to the entire community. On the RFQ create/edit web page 301 the community participant 52 defines the effective dates for a new RFQ, specifying when it should be posted and when it should be removed. In addition, the community participant 52 can edit all aspects of an existing RFQ, being able to re-define the reviewers and the associated workflow steps of the web form. The community participant 52 is also able to update, remove, or add data files as needed, thereby changing the revision status of the RFQ. The owner/participant can also delete the RFQ, which will trigger appropriate notifications to be sent to the initiators and effected suppliers.

The purpose of the RFQ quote web page 302 is to allow the supplier to enter a quote packet in response to a specific RFQ. The supplier is able to initiate a response directly from the RFQ packet itself (see FIG. 11). As illustrated by FIG. 10B, the RFQ quote web page 302 has links to two second tier web pages, particularly define team/flow web page 302-1 and add files/docs web page 302-2.

Every RFQ has a button for creating a response to the RFQ. When depressed, this button automatically generates a response to RFQ packet. The supplier is able to add or remove any documents from the response to RFQ packet, e.g., using add files/docs web page 302-2. Using e.g., the define team/flow web page 302-1, the RFQ owner has the ability to designate which colleagues will be involved in the RFQ quote evaluation, and how they will work together through the selection of particular workflow. Upon submittal of a response to RFQ by a supplier, a notification is sent automatically to the RFQ initiator.

The purpose of the RFQ browser page 303 is to allow a supplier to find and preview the contents of any applicable RFQ. As illustrated by FIG. 10C, the RFQ browser web page 303 has links to six second tier web pages, particularly RFQ find web page 303-1; RFQ edit web page 303-2; RFQ view web page 303-3; RFQ question web page 303-4; RFQ activity web page 303-5; and, RFQ close web page 303-6. Example contents of each of the web pages 303-1 and 303-3 through 303-5 are illustrated in FIG. 12A-FIG. 12D, respectively.

Using RFQ find web page 303-1 (see FIG. 12A), a supplier is able to query for all RFQs that match its company's classification data, to view RFQs by category, or just request to view all RFQs on the community bulletin board. A community participant 52 is able to use this web page to list all RFQs that they have posted (active and by date).

Using RFQ view web page 303-3 (see FIG. 12B), a supplier is able to open a specific RFQ packet from the find list, inspect any and all business requirements, and view all data document types contained in the RFQ packet. The supplier is also able to print out any of the data documents.

Using RFQ question web page 303-4 (see FIG. 12C), a supplier is able to pose clarification questions to the RFQ initiator in the form of written questions using redlined or markup versions of the RFQ documents to support the questions.

Using RFQ activity web page 303-5 (see FIG. 12D), a supplier is able to view all supplier activity on any or all of the there-entered RFQs. The supplier is able to view all workflow activities on a specific RFQ, and is able to see where the RFQ is in the process, as well as printout out an activity report.

Using RFQ close web page 303-6, a supplier is able to close a specific RFQ by assigning it a purchase order (PO). Quotes that are not awarded purchase orders are notified of the decision automatically.

The product definition data structure 60 of the present invention differs from conventional product definition data structures in significant ways, only some of which are now summarized. A first difference is that, while using XML as a core, the product definition data structure of the present invention incorporates other data not supported by other product definition data structures. A second difference is that the product definition data structure of the present invention can include rules relating to how the product operates with other components. A third difference is that the product definition data structure of the present invention maintains association of related items of information for the product, e.g., automatic updating of a design change to the files contributing to the product. A fourth difference is that the product definition data structure of the present invention supports multiple other standardized product definition data structures, e.g., PDX and RosettaNet.

The product design server system 20 of the present invention goes beyond web-enabled and IP-based architectures by providing a pure internet architecture approach. Unlike other systems, the product design server system 20 does not require a relational database at the heart of the system for data storage. Instead, a web server is the core of the application server. In addition, the native format of the application server is XML.

A rich set of component technology and tools furnished by applications server 40 provides powerful capabilities to the application services 70. Capabilities provided include locating, vaulting, accessing, publishing, viewing, routing, notification, and even modification of types of product-related information. The breadth of product data supported includes standard office documents (texts, spreadsheets, etc.), product definitions (BOMs, etc.), as well as complex two dimensional and three dimensional CAD data formats that document a product design.

Relational database technology requires a complex schema to be understood and encoded in meta data tables, resulting in the long expensive implementation cycles that are renowned with enterprise software. In addition, a risk of major corruption exists if the meta data becomes out of synchronization with the real data. Using the analogy of a library, traditional technologies require a card (meta data) to be cataloged for each book (data file), and any changes must be reflected in both. The product design server system 20 of the present invention does away with the old catalog approach by using index server technology to look inside the books (data files) and dynamically update even an index whenever a change is sensed. Implementation is fast and extremely flexible since the system updates itself when changes are made. Freeing the system from relational database technology enhances flexibility while simplifying implementation and maintenance.

The native data being XML allows the product design server system 20 to connect, interact, and integrate with countless other applications, including many new web-based, business-to-business applications.

Because the application services 70 use a browser as the interface, minimal training and installation are required. Community participants simply enter the URL of a server, either across the Internet or through a network, for automatic download of software and updates. The browser-based interfaces makes it possible for any community participant to access, view, and understand information—including visual, three dimensional data.

The product design server system 20 with its applications server 40 supports document types that include CAD models and drawings such as ProEngineer and Solidworks, AutoCad™ drawings, IronCAD™ scenes and drawings, Microsoft® Office, and web documents, including standard file types and viewable by browser (GIF, JPEG, TXT). Documents that web browsers read via plug-ins, such as VRML and PDF, are also supported.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

```
TABLE 1
<Schema name = “vdsProdDef.biz”
  xmlns = “urn:schemas-microsoft-com:xml-data”
  xmlns:dt = “urn: schemas-microsoft-com:datatypes”>
  <ElementType name = “Product” content = “eltOnly” order = “seq”>
```

<AttributeType name = “name” dt:type = “string”/>
<AttributeType name = “revision” dt:type = “string”/>
<AttributeType name = “definition” dt:type = “string”/>
<AttributeType name = “minorRevision” dt:type = “string”/>
<AttributeType name = “category” dt:type = “string”/>
<AttributeType name = “type” dt:type = “string”/>
<AttributeType name = “dictionary-ref” dt:type = “string”/>
<AttributeType name = “id” dt:type = “string”/>
<attribute type = “name”/>
<attribute type = “revision”/>
<attribute type = “definition”/>
<attribute type “minorRevision”/>
<attribute type = “category”/>
<attribute type = “type”/>
<attribute type = “dictionary-ref”/>
<attribute type = “id”/>
© Alventive 2000

```
TABLE 2
  <element type = “PartNumber”/>
<ElementType name = “AltPartNumber” content = “textOnly”>
  <AttributeType name = “organization” dt:type = “string”/>
  <AttributeType name = “generationRule” dt:type = “string”/>
  <attribute type = “organization”/>
  <attribute type = “generationRule”/>
</ElementType>
<ElementType name = “AltPartNumbers” content = “eltOnly” order =
“seq”>
  <element type = “AltPartNumber” minOccurs = “0” maxOccurs =
  “*”/>
</ElementType>
<ElementType name = “PartNumber” content = “textOnly”>
  <AttributeType name = “generationRule” dt:type = “string”/>
  <AttributeType name = “organization” dt:type = “string”/>
  <attribute type = “generationRule”/>
  <attribute type = “organization”/>
</ElementType>
© Alventive 2000
```

```
TABLE 3
<ElementType name = “bom” content = “eltOnly” order =“seq”>
  <element type = “bom_item” minOccurs = “0” maxOccurs = “*”/>
  <attribute type = “type”/>
  <element type = “bom_item” minOccurs = “0” maxOccurs “*”/>
</ElementType>
<ElementType name = “bom_item” content = “eltOnly” order = “seq”>
  <AttributeType name = “item_id” dt:type = “string”/>
  <AttributeType name = “qty” dt:type = “string”/>
  <AttributeType name “notes” dt:type = “string”/>
  <attribute type = “item id”/>
  <attribute type = “qty”/>
  <attribute type = “notes”/>
  <element type “ProductRef”/>
</ElementType>
<ElementType name = “ProductRef” content = “empty”>
  <AttributeType name = “id” dt:type = “string”/>
  <AttributeType name = “dictionary-ref” dt:type = “string”/>
  <AttributeType name = “name” dt:type = “string”/>
  <attribute type = “id”/>
  <attribute type = “dictionary-ref”/>
  <attribute type = “name”/>
</ElementType>
© Alventive 2000
```

```
TABLE 4
  <ElementType name = “specifications” content = “eltOnly” order =
  “one”>
    <group order = “seq”?
      <element type = “feature” minOccurs = “0” maxOccurs = “*”/>
      <element type = “characteristic” minOccurs = “0” maxOccurs =
      “*”/>
    </group>
    <element type = “specification” minOccurs = “0” maxOccurs =
    “*”/>
  </ElementType>
  <ElementType name = “specification” content = “empty”>
    <AttributeType name = “name” dt:type = “string”/>
    <AttributeType name = “value” dt:type = “string”/>
    <AttributeType name “dictionary-ref” dt:type = “string”/>
    <attribute type = “name”/>
    <attribute type = “value”/>
    <attribute type = “dictionary-ref”/>
  </ElementType>
  <ElementType name = “feature” content = “eltOnly” order =“seq”>
    <AttributeType name “name” dt:type “string” required = “yes”/>
    <AttributeType name = “definition” dt:type = “string” required =
    “yes”/>
    <AttributeType name = “dictionary-ref” dt:type = “string”/>
    <attribute type “name”/>
    <attribute type = “definition”/>
    <attribute type = “dictionary-ref”/>
    <element type = “value-domain”/>
  </ElementType>
  <ElementType name = “value-domain” content “eltOnly” order =
  “seq”>
    <element type = “value” minOccurs = “1” maxOccurs = “*”/>
  </ElementType>
  <ElementType name = “value” content = “textOnly”/>
  <ElementType name = “characteristic” content = “eltOnly” order =
  “seq”>
    <AttributeType name = “name” dt:type = “string” required = “yes”/>
    <AttributeType name = “definition” dt:type = “string” required =
    “yes”/>
    <AttributeType name = “dictionary-ref” dt:type = “string”/>
    <AttributeType name = “minInclusive” dt:type = “enumeration”
    dt:values = “0”/>
    <AttributeType name = “dimension” dt:type = “string” required =
    “yes”/>
    <AttributeType name = “maxInclusive” dt:type = “enumeration”
    dt:values = “100”/>
    <AttributeType name = “dataType” dt:type = “enumeration”
    dt:values = “int real” required “yes”/>
    <AttributeType name = “minExclusive” dt:type = “enumeration”
    dt:values = “0”/>
    <attribute type = “name”/>
    <attribute type = “definition”/>
    <attribute type = “dictionary-ref”/>
    <attribute type = “minInclusive”/>
    <attribute type = “dimension”/>
    <attribute type = “maxInclusive”/>
    <attribute type = “dataType”/>
    <attribute type = “minExclusive”/>
    <element type = “units”/>
  </ElementType>
<ElementType name = “units” content = “textOnly”/>
  © Alventive 2000
```

```
TABLE 5
<ElementType name = “DocGroup” content = “eltOnly” order = “seq”>
  <element type = “default” minOccurs = “1” maxOccurs = “*”/>
</ElementType>
<ElementType name = “name” content = “textOnly”/>
<ElementType name “default” content = “eltOnly” order = “seq”>
  <AttributeType name = “ID” dt:type = “string”/>
  <attribute type “ID”/>
  <element type = “ci” minOccurs = “1” maxOccurs = “*”/>
</ElementType>
<ElementType name = “ci” content “eltOnly” order = “seq”>
  <AttributeType name = “t” dt:type = “string”/>
  <AttributeType name = “number” dt:type = “string”/>
  <attribute type = “t”/>
  <attribute type = “number”/>
  <element type = “name”/>
  <element type = “vpath”/>
  <element type = “guid”/>
</ElementType>
<ElementType name = “vpath” content = “textOnly”/>
<ElementType name = “guid” content = “textOnly”/>
© Alventive 2000
```

```
TABLE 6
<ElementType name = “change_history” content = “eltOnly” order =
“seq”>
  <element type = “change_history item” minOccurs = “0” maxOccurs =
“*”/>
</ElementType>
<ElementType name = “change_{═}history_{═}item” content = “textOnly”>
  <AttributeType name = “revision” dt:type = “string”/>
  <AttributeType name = “number” dt:type = “string”/>
  <AttributeType name = “type” dt:type = “string”/>
  <AttributeType name = “description” dt:type = “string”/>
  <attribute type = “revision”/>
  <attribute type = “number”/>
  <attribute type = “type”/>
  <attribute type = “description”/>
</ElementType>
© Alventive 2000
```

```
TABLE 7
<ElementType name = “Rules” content = “eltOnly” order = “seq”>
  <element type = “InterProductRule” minOccurs = “0” maxOccurs =
“*”/>
  <element type = “InterSpecificationRule” minOccurs = “0” maxOccurs
=“*”/>
</ElementType>
<ElementType name = “InterProductRule” content = “textOnly”>
</ElementType>
<ElementType name = “InterSpecificationRule” content = “textOnly”>
</ElementType>
© Alventive 2000
```

What is claimed is:

1. A system for allowing participants of a product community to interact with product definition data pertinent to at least a portion of a lifecycle of the product, the system comprising:
a community server accessible via a network by the participants of the product community and which uses the product definition data;
plural application suites executed by the community server for permitting interaction with the product definition data by corresponding plural differing types of participants.

2. The system of claim 1, wherein the interaction includes plural ones of the following:
(1) viewing the product definition data;
(2) revising the product definition data;
(3) routing the product definition data;
(4) notifying other participants of modification of the product definition data.

3. The system of claim 1, wherein the plural differing types of participants include a component supplier for the product; a designer for the product; a customer for the product; a marketer for the product.

4. The system of claim 1, wherein the lifecycle includes product design, product production, product delivery/distribution, product marketing and sales, and product support.

5. The system of claim 1, wherein the product definition data includes data for providing a three dimensional display of at least a portion of the product.

6. The system of claim 1, wherein the plural application suites include at least one of the following:
(1) a supplier participation suite through which a component supplier for the product interacts with the product design data;
(2) a customer participation suite through which a customer of the product interacts with the product design data;
(3) an engineering participation suite through which a designer of the product interacts with the product definition data.

7. The system of claim 1, wherein the plural application suites include a supplier participation suite through which a component supplier for the product performs at least one of the following:
responds to a request for a quote for a component of the product;
tracks a job to determine progress/stage of an implementation or change process.

8. The system of claim 1, wherein the plural application suites include a customer participation suite through which a customer supplier for the product performs at least one of the following:
views a three dimensional image of the product;
provides feedback comment regarding the product.

9. A network-based product development community system comprising:
a network node for storing product definition data pertinent to at least a portion of a lifecycle of the product;
a network node for each of plural participants of the product development community through which the respective participants interact with the product definition data;
a community server situated at a node of the network which, when a change affecting the product definition data occurs as a result of interaction by a first participant, notifies others of the plural participants of the change.

10. The system of claim 9, wherein the network is an enterprise network and the nodes are nodes of the enterprise network.

11. The system of claim 9, wherein the network is the Internet and the nodes are nodes of the Internet.
